(19) United States
(12) Patent Application Publication
(10) Pub. No.: US 2025/0247219 A1
(43) Pub. Date: Jul. 31, 2025

(54) METHOD AND APPARATUS FOR GENERATING A QUANTUM CRYPTOGRAPHIC KEY

(71) Applicant: Wave Photonics Ltd, Cambridge (GB)

(72) Inventors: James Patrick Lee, Cambridge (GB); Friederike Bettina Jöhlinger, Cambridge (GB); Andriy Boubriak, Cambridge (GB)

(73) Assignee: Wave Photonics Ltd, Cambridge (GB)

(21) Appl. No.: 18/854,344

(22) PCT Filed: Apr. 4, 2023
(86) PCT No.: PCT/GB2023/050895

§ 371 Date: Oct. 4, 2024

(30) Foreign Application Priority Data
Apr. 5, 2022 (GB) 2204976.1

(51) Int. Cl. H04L 9/08; H04B 10/70

(52) U.S. Cl. CPC H04L 9/0858; H04B 10/70

(57) ABSTRACT

There is presented an apparatus for generating a quantum cryptographic key by outputting an EM pulse/a set of EM pulses to a further apparatus. One or more electromagnetic pulse sources are for outputting at least a first set of one or more EM pulses and a second set of one or more EM pulses. A random phase relationship exists between a first EM pulse and a second EM pulse. An optical element (BS3) receives the first EM pulse and the second EM pulse and is configured to interfere the first EM pulse with the second EM pulse and output an interfered EM pulse along an output path. Further optical elements BS4 and BS5 are used to split off a portion of the output pulses for measuring the properties of the interfered EM pulses. In one example, at least one EM attenuator is configured to attenuate the said received EM pulse such that the attenuated EM pulse comprises an average of up to one photon. The attenuated pulse is output towards a further apparatus, for generating the quantum cryptographic key.

### FIELD OF THE INVENTION

The field of the present invention is quantum key distribution (QKD), in particular, but not limited to, transmitters that can be used with already existing receivers and transmitters with specialised receivers.

### BACKGROUND

QKD, where a secure cryptographic key is created between two parties using the properties of quantum mechanics, is an important cryptographic primitive in the field of quantum communication.

The created cryptographic key is known to the two participating parties, but unknown to anyone else. The main traditional cryptographic alternative is public key cryptography, which bases its security on mathematically hard problems, which are slow, but not entirely impossible to solve with current mathematical tools. QKD on the other hand uses the intrinsic properties of quantum mechanics to monitor for eavesdroppers and other third parties. At the end of the exchange, it will be clear if key has been leaked to a third party and therefore insecure, or if it has not been leaked and is therefore secure to use in further cryptographic protocols.

An advantage of QKD over traditional cryptographic key exchanges is that, based on current understanding, the intrinsic properties of quantum mechanics are unchangeable and, crucially, prevent copying and storing exchanged key data. New mathematical tools could however be developed to solve the hard mathematical problems underlying traditional cryptographic methods. Additionally, traditional cryptography has no mechanism to prevent exchanged information from being copied and stored for future decrypting. This means that a key created with QKD has a security advantage when used with long-term classified data. QKD is therefore also called future-proof.

Various implementations of QKD transmitters and receivers have been created to date. Each QKD device sends encoded symbols from the transmitter to the receiver device(s). For clarity of descriptions, in a 2-device protocol the transmitting party is denoted ALICE and the receiving party is denoted BOB. For 3-device protocols, where two parties transmit to a third party, who is ignorant of the actual key, the two transmitting parties are denoted ALICE and BOB and the receiving party is denoted CHARLIE. The encoded symbols consist of quantum states of zero or more photons and each symbol corresponds to a potential key bit.

The first and one of the more widely used QKD protocol is known as BB84. It is a 2-device protocol, where, in the simplest form of the protocol, ALICE sends single photons to BOB encoded in one of four quantum states. The first state, denoted |0 [symbol] , is orthogonal to the second state, denoted |1 [symbol] . This means that one can distinguish with certainty between a |0 [symbol] or |1 [symbol] quantum state and these two states create the first measurement basis of the protocol. The third state, denoted |+ [symbol] , is orthogonal to the fourth state, denoted |− [symbol] and these two states create the second measurement basis of the protocol. However, |0 [symbol] is not orthogonal to |+ [symbol] , nor to |− [symbol] and |1 [symbol] is also not orthogonal to |+ [symbol] or |− [symbol] . Specifically, if measuring in the first measurement basis when either state from the second measurement basis is sent, the measurement outcome is random, with the measurement outcome indicating |0 [symbol] and the measurement outcome indicating |1 [symbol] equally likely to happen. The same applies when measuring any state from the first measurement basis in the second measurement basis. This means that it is impossible to distinguish with certainty between the four possible quantum states ALICE can prepare and send.

Similarly, when an eavesdropper, denoted EVE, would measure the state after ALICE sent the state and before BOB receives the state, she will also not be able to distinguish between the four possible states. Moreover, if she measures in the incorrect measurement basis, she also changes the state from the original state to one of the states in the measurement basis used.

These properties can be used for QKD in the following way: ALICE prepares one of the four quantum states at random and sends it to BOB. BOB then selects a measurement basis at random and measures the state. These two steps are repeated multiple times. Afterwards, ALICE and BOB compare the measurement bases they used for each photon, without disclosing the measured state.

They discard all cases where they used different measurement bases and keep all cases where they used the same. A subset of the remaining outcomes is used to establish the existence of errors: cases where the state sent was prepared in the same measurement bases as BOB measured in, but ALICE and BOB do not agree on which of the two basis states in this measurement basis was used. The existence of errors implies that an eavesdropper has performed measurements on the state while in transit between ALICE and BOB and therefore that the key is compromised. Depending on the error rate and therefore the amount of key information leaked to EVE, ALICE and BOB can either perform privacy amplification to eliminate EVE's knowledge of the shared key to create a fully secure, though shorter key or, in case too much key has been leaked, fully discard the key.

Since there are no deterministic single photon sources available yet, but only single photon sources where the creation of a photon is probabilistic, instead of single photons most implementations use coherent states with average intensities of less than one photon per state. This creates a known vulnerability, however, the photon number splitting attack, which can be circumvented using a so-called decoy state method. Without the decoy state method one can often still create a secure key using coherent states instead of single photons, however this tends to decrease the key generation rate drastically.

In FIG. 1 a table showing a possible 10-symbol BB84 QKD exchange can be found, including measurements by an eavesdropper EVE at each symbol. The ROUND value indicates the symbol in the sequence of all ten symbols in the exchange. For each participant, the random basis selection is noted. For ALICE, the preparation basis and for EVE and BOB the measurement basis. The table also shows the state assumed by each participant. For ALICE, the state she prepared and for EVE and BOB the state indicated by their measurement outcome. For EVE this state is the same as the state sent on to BOB.

For ROUND 3, 5, 6, 9 and 10, ALICE and EVE use the same basis, so EVE measures what state ALICE has sent. In the other cases, ROUND 1, 2, 4, 7, and 8, EVE's basis is different from ALICE's basis, so EVE's measurement result is random.

For ROUND 1, 5, 6, 8 and 9, ALICE and BOB use different bases, so these cases are discarded. For ROUND 2, 3, 4, 7 and 10 ALICE and BOB use the same bases and without an eavesdropper they should agree on which state ALICE sent. For ROUND 2, 4 and 7, however, EVE measures in a different basis than BOB and ALICE while the state is in transit between ALICE and BOB. This means that the measurement outcome at BOB is random in these cases.

For ROUND 4, BOB happens to measure the right state, so EVE does not cause an error, however, this outcome is probabilistic. For ROUND 2 and 7, BOB measures a different state than ALICE sent, despite using the same basis, which is made possible by EVE measuring in the incorrect basis in between.

Finally, BOB and ALICE compare a subset of their results. When they notice they have an error in ROUND 2 or 7, they know there is an eavesdropper in the exchange and the key needs to be either discarded or privacy amplification needs to be employed.

The four states used in the BB84 protocol, and any other state used by different QKD protocols, can be created using various types of encoding, depending on what physical properties are employed. Common quantities used are polarisation, timing, relative phase and orbital angular momentum.

Conventionally, active optical elements such as phase modulators, intensity modulators and optical switches are used to encode a symbol. These active optical elements require random input signals to encode usable symbols, which are based on random numbers created by random number generators (RNGs). RNGs may be quantum as well: quantum random number generators (QRNGs).

The active optical elements require coordination of their inputs to encode the symbols accurately, which in turn requires complex electronics. The requirement of (Q)RNGs also adds complexity to the setup and increases the footprint of the transmitter devices.

The general complexity of the required transmitters and receiver devices creates a significant threshold for a company or organisation to develop their own QKD system and pushes them to buy a complete system from a vendor. Due to being future-proof, QKD is very suitable for highly sensitive data. Users with such data may not want to rely on a QKD system manufacturing company and prefer to build their own system.

### SUMMARY

In a first aspect there is presented an apparatus for generating one or more interfered pulses for outputting to a further apparatus for the generation of a quantum cryptographic key; the apparatus comprising: I) one or more electromagnetic, EM, pulse sources for outputting at least a first set of one or more EM pulses (preferably two or more) and a second set of one or more EM pulses (preferably two or more); wherein: at least a first EM pulse is based from at least one of the first set of EM pulses; and, at least a second EM pulse is based from at least one of the second set of EM pulses; wherein: a) a random phase relationship exists between the first EM pulse and the second EM pulse; b) each of the first and second EM pulses comprises a plurality of photons; II) an optical element (BS3) comprising: c) a first input path (a) for receiving the first EM pulse; d) a second input path (b) for receiving the second EM pulse; e) at least one output path (c, d); wherein: the first input path (a) is spatially separate to the second input path (b); the optical element (BS3) is configured to: interfere the first EM pulse with the second EM pulse; output an interfered EM pulse along the at least one output path (c); III) at least one EM attenuator configured to: receive the interfered EM pulse; attenuate the said received EM pulse such that the attenuated EM pulse comprises an average of up to one photon; output the attenuated pulse, towards a further apparatus, for generating the quantum cryptographic key.

The first aspect may be adapted according to any teaching herein including but not limited to any one or more of the following.

The first and second sets of EM pulses may be used to generate a quantum cryptographic key by together forming different values of one or quantum cryptographic bases. These bases may be for a BB84 protocol or another quantum cryptographic protocol.

The phase relationship is random in that it is not predetermined and is only determined by measurement.

The apparatus may be configured such that:
the at least one output path comprises at least a first (c) and second (d) output path; the first output path is spatially separate from the second output path;
the interfered EM pulses along the first (c) and second (d) output paths being associated with a path-encoded quantum cryptographic basis.

The at least one EM attenuator may be configured to attenuate interfered EM pulses output from the first and second output paths.

The apparatus as may further comprise an encoder for:
receiving interfered EM pulses output from the first and second output paths; and,
changing the path encoded quantum cryptographic basis to a different quantum cryptographic basis encoding. The changing of the basis may optionally be achieved using linear optical components. In some non-limiting examples only linear optical components are used to change the encoding type.

The apparatus may be configured such that the encoder is configured to change a path-encoded quantum cryptographic basis to a polarisation-encoded cryptographic basis.

The polarisation encoder may be a component that: a) outputs EM pulses from the first output path with a first polarisation b) outputs EM pulses from the first output path with a second polarisation orthogonal to the first polarisation. The first polarisation may be the horizontally polarisation. The second polarisation may be the vertical polarisation. The encoder may output a temporally and spatially overlapped output EM pulse.

The polarisation encoder may be a 2D grating. The polarisation encoder may be formed on a common platform to any of the other components of the apparatus. For example, the polarisation encoder may be formed as an integrated optic components monolithically integrated with waveguides carrying the interfered EM pulses. The encoder may alternatively be a path to time-based encoder. The encoder may be arranged to receive the interfered EM pulses before they are incident upon the attenuator, or alternatively receive the interfered EM pulses after they are output from the attenuator.

The apparatus may further comprise a first set of further optical elements (BS4, BS5); the first set comprising at least a first optical element (BS4) and a second optical element (BS5); wherein: I) the first optical element of the first set configured to: i) receive the interfered EM pulse from the first (c) output path; ii) output a first portion of the said received interfered EM pulse on a path (e) towards the further apparatus; iii) output a second portion on the received interfered EM pulse on a path (g) towards an arrangement of components comprising at least one EM detector (PD1, PD2, PD3, PD4); the said second portion referred to as a first check pulse; II) the second optical element of the first set configured to: i) receive the interfered EM pulse from the second (d) output path; ii) output a first portion of the said received interfered EM pulse on a path (f) towards the further apparatus; iii) output a second portion on the received interfered EM pulse on a path (h) towards the arrangement of components comprising at least one EM detector (PD1, PD2, PD3, PD4); the said second portion referred to as a second check pulse.

The apparatus may be configured such that the at least one EM detector comprises:
a first EM detector (PD4) for receiving at least a first sub-portion of the first check pulse;
a second EM detector (PD1) for receiving at least a first sub-portion of the second check pulse.

The apparatus may be configured such that the arrangement of components comprises:
a third EM detector (PD2) for receiving at least a:
   second sub-portion of the first check pulse; and
   second sub portion of the second check pulse;
a fourth EM detector (PD3) for receiving at least a:
   third sub-portion of the first check pulse; and
   third sub portion of the second check pulse.

The apparatus may be configured such that at least one of the optical paths carrying any one of:
a) the second sub-portion of the first check pulse; and
b) the second sub portion of the second check pulse;
c) the third sub-portion of the first check pulse; and
d) the third sub portion of the second check pulse.
   comprises a longer path length that the other of the said sub-portions.

More particularly that optionally: a) one of: the second sub-portion of the first check pulse; incurs a delay reaching the third EM detector, with respect to the second sub portion of the second check pulse, or vice versa; or, b) one of: the third sub-portion of the first check pulse; incurs a delay reaching the third EM detector, with respect to the third sub portion of the second check pulse, or vice versa.

This path length difference may be any length.

The apparatus may further comprise a second set of one or more further optical elements (BS6, BS7, BS8, BS9) for:
a) receiving the first and second check pulses; and,
b) creating the first, second and third sub portions of the first check pulse; and,
c) creating the first, second and third sub portions of the second check pulse.

The third EM detector and fourth EM detector may each output one or more electrical signals, upon receiving the different portions of the check pulses. These electrical signals may be used to determine the phase differences between the first and second EM pulses.

The first EM detector (PD4) may output corresponding electrical signals used to determine the amplitude of the first portion of the interfered EM pulse from the first (c) output path that is output towards the further apparatus.

The second EM detector (PD1) may output corresponding electrical signals used to determine the amplitude of the first portion of the interfered EM pulse from the second (d) output path that is output towards the further apparatus.

The apparatus may be configured such that the optical element (BS3) is a first optical element; the apparatus further comprising: I) a second optical element (BS1) for: i) receiving an EM pulse from the first set of EM pulses; ii) receiving an EM pulse from a third set of two or more EM pulses; wherein a random phase relationship exists between the first set of EM pulses and the third set of EM pulses; iii) interfering the two received EM pulses; iv) outputting the interfered EM pulse as the first EM pulse for inputting into the first optical element; II) a third optical element (BS2) for: i) receiving an EM pulse from the second set of EM pulses; ii) receiving an EM pulse from a fourth set of two or more EM pulses; wherein a random phase relationship exists between the second set of EM pulses and the fourth set of EM pulses; iii) interfering the two received EM pulses iv) outputting the interfered EM pulse as the second EM pulse for inputting into the first optical element.

The apparatus may be configured such that any two or more of the sets of EM pulses share a common EM pulse source.

The apparatus may be configured such that at least one of the EM pulse sources comprises a gain-switched laser.

The apparatus may further comprise an integrated optic device comprising at least the wherein the optical element.

In a second aspect there is presented an apparatus for generating a set of pulses for outputting to a further apparatus for the generation of a quantum cryptographic key; the apparatus comprising: I) one or more electromagnetic, EM, pulse sources for outputting at least a first set of two or more EM pulses and a second set of two or more EM pulses; wherein: at least a first EM pulse is based from at least one of the first set of EM pulses; and, at least a second EM pulse is based from at least one of the second set of EM pulses; wherein: a) a random phase relationship exists between the first EM pulse and the second EM pulse; b) a random phase relationship exists between the pulses of the first set of pulses; c) each of the first and second EM pulses comprises a plurality of photons; II) an optical element (BS18) comprising: d) a first input path for receiving the first EM pulse; e) a second input path for receiving the second EM pulse; f) at least one output path; wherein: the first input path is spatially separate to the second input path; the optical element (BS18) is configured to output at least: i) a portion of the first EM pulse; ii) a portion of the second EM pulse; along the at least one output path; the apparatus is further configured to: output the portion of the first EM pulse such that the said portion comprises an average of up to one photon; output the portion of the first EM pulse and the portion of the second EM pulse, in different time bins, towards a further apparatus, for generating the quantum cryptographic key.

The second aspect may be adapted according to any teaching herein including but not limited to any one or more of the following.

The first set of EM pulses may be signal pulses for transmitting to the further apparatus such as a receiver apparatus. The receiver apparatus may be referred to as ‘Charlie’ in examples herein. The second set of EM pulses may be reference pulses. Reference pulses output by the apparatus, and received by the receiver apparatus typically contain a plurality of photons.

The apparatus may be configured such that the optical element is a first optical element; the apparatus further comprising: I) a second optical element for: i) receiving an EM pulse from the first set of EM pulses; ii) amplitude splitting the received EM pulse such that: a first portion is output as the first EM pulse to the first optical element; a second portion is output towards a heterodyne detection arrangement; II) a third optical element for: iii) receiving an EM pulse from the second set of EM pulses; iv) amplitude splitting the received EM pulse such that: a first portion is output as the second EM pulse to the first optical element; a second portion is output towards the heterodyne detection arrangement.

The apparatus may further comprise a delay line for receiving the second portion output by the third optical element (BS17) and outputting the delayed second portion towards the heterodyne detection arrangement.

The apparatus may be configured such that the heterodyne detection arrangement comprises: I) first and second EM detectors; II) a fourth optical element (BS4) for: A) receiving: i) the second portion from the second optical element; ii) the second portion from the third optical element; B) interfering EM pulses received from the first and second sets of EM pulses; C) outputting interfered EM pulses to the first and second EM detectors.

The apparatus may be configured such that the second set of EM pulses have greater intensity than the first set of EM pulses.

A system is presented comprising at least two of the apparatus as described above; the at least two apparatus being a first transmitter apparatus (ALICE) and a second transmitter apparatus (BOB).

The system may further comprise the further apparatus, wherein the further apparatus comprises: I) a single photon detection arrangement; II) a further heterodyne detection arrangement; III) a fifth optical element for: i) receiving the output first pulse from the first transmitter apparatus; ii) outputting a first portion of the said received first pulse towards the single photon detection arrangement; iii) outputting a second portion of the said received first pulse towards the heterodyne detection arrangement; IV) a sixth optical element for: i) receiving the output first pulse from the second transmitter apparatus; ii) outputting a first portion of the said received first pulse towards the single photon detection arrangement; iii) outputting a second portion of the said received first pulse towards the heterodyne detection arrangement.

In a third aspect there is presented a method for outputting an EM pulse from an apparatus, for generating a quantum cryptographic key with a further apparatus; the method comprising: interfering a first EM pulse and a second EM pulse; the first and second EM pulses each comprising a plurality of photons and having a random phase relationship with each other; the first EM pulse being based from at least one of a first set of EM pulses; the second EM pulse being based from at least one of a second set of EM pulses; outputting a first interfered EM pulse along a first output path; attenuating the interfered EM pulse such that the attenuated EM pulse comprises an average of up to one photon; output the attenuated pulse, towards a further apparatus, for generating the quantum cryptographic key. The third aspect may be adapted according to any teaching herein including but not limited to any one or more of the following.

The method may further comprise:
outputting a second interfered EM pulse along a second output path that is different to the first output path;
outputting the first interfered EM pulse as a first polarisation signal;
outputting the second interfered EM pulse as a second polarisation signal; the first polarisation being orthogonal to the second polarisation;
outputting a composite EM pulse by spatially and temporally overlapping the first and second polarisation signal.

The method may optionally use an apparatus comprising only EM pulse sources, EM detectors and passive, linear optical elements.

The method may optionally use an apparatus comprising only EM pulse sources, EM detectors and passive, linear optical elements.

In a fourth aspect there is presented an apparatus for generating a quantum cryptographic key by outputting an EM pulse to a further apparatus; the apparatus comprising: I) an optical element (BS3) comprising: i) a first input path (a) for receiving a first EM pulse; ii) a second input path (b) for receiving a second EM pulse; iii) at least one output path (c, d); wherein: the first input path (a) is spatially separate to the second input path (b); the optical element (BS3) is configured to: interfere the first EM pulse with the second EM pulse; output a first interfered EM pulse along a first output path (c); output a second interfered EM pulse along a second output path (c); II) a first set of further optical elements (BS4, BS5); the first set comprising at least a first optical element (BS4) and a second optical element (BS5); wherein: A) the first optical element of the first set is configured to: a) receive the first interfered EM pulse from the first (c) output path; b) output a first portion of the said received first interfered EM pulse on a path (e) towards the further apparatus; c) output a second portion on the received first interfered EM pulse; the said second portion referred to as a first check pulse; B) the second optical element of the first set configured to: d) receive the second interfered EM pulse from the second (d) output path; e) output a first portion of the said received second interfered EM pulse on a path (f) towards the further apparatus; the first portions of the respective first and second interfered EM pulses being associated with a path-encoded quantum cryptographic basis; f) output a second portion on the received second interfered EM pulse; the said second portion referred to as a second check pulse; III) a second set of further optical elements configured to:
receive the first and second check pulses; and,
create spatially separated first, second and third sub portions of the first check pulse; and,
create spatially separated first, second and third sub portions of the second check pulse; and,
output the said sub portions in steps i) and j) for detection.

The fourth aspect may be adapted according to any teaching herein including but not limited to any one or more of the following.

The apparatus may further comprise an encoder configured to:
i) receive the first portion of the first interfered EM pulse;
ii) receive the first portion of the second interfered EM pulse;
iii) change the path encoded quantum cryptographic basis to a different quantum cryptographic basis encoding.

The apparatus may be configured such that the encoder is configured to change a path-encoded quantum cryptographic basis to a polarisation-encoded cryptographic basis.

The apparatus may be configured such that the optical element is a first optical element; the apparatus further comprising:

I) a second optical element for:
i) receiving an EM pulse from a first set of two or more EM pulses;
ii) receiving an EM pulse from a third set of two or more EM pulses;
iii) interfering the two received EM pulses;
iv) outputting the interfered EM pulse as the first EM pulse for inputting into the first optical element;

II) a third optical element for:
i) receiving an EM pulse from a second set of two or more EM pulses;
ii) receiving an EM pulse from a fourth set of two or more EM pulses;
iii) interfering the two received EM pulses;
iv) outputting the interfered EM pulse as the second EM pulse for inputting into the first optical element.

The apparatus may be configured such that the first, second and third optical elements are integrated optical elements monolithically integrated to form a common device.

In a fifth aspect there is presented an apparatus for generating a quantum cryptographic key by outputting one or more EM pulses to a further apparatus; the apparatus comprising: I) one or more electromagnetic, EM, pulse sources for outputting at least a first set of one or more EM pulses and a second set of one or more EM pulses; wherein at least a first EM pulse is based from at least one of the first set of EM pulses; and, at least a second EM pulse is based from at least one of the second set of EM pulses; wherein: i) a random phase relationship exists between the first EM pulse and the second EM pulse; ii) each of the first and second EM pulses comprises a plurality of photons; II) an optical element (BS3) comprising: i) a first input path (a) for receiving a first EM pulse; ii) a second input path (b) for receiving a second EM pulse; iii) at least two output paths (c, d); wherein: the first input path (a) is spatially separate to the second input path (b); the optical element (BS3) is configured to: interfere the first EM pulse with the second EM pulse; output a first interfered EM pulse along a first output path (c); output a second interfered EM pulse along a second output path (d); III) a first set of further optical elements (BS4, BS5); the first set comprising at least a first optical element (BS4) and a second optical element (BS5); wherein: A) the first optical element (BS4) of the first set is configured to: a) receive the first interfered EM pulse from the first (c) output path; b) output a first portion of the said received first interfered EM pulse on a path (e) towards the further apparatus; c) output a second portion on the received first interfered EM pulse; the said second portion referred to as a first check pulse; B) the second optical element (BS5) of the first set configured to: d) receive the second interfered EM pulse from the second (d) output path; e) output a first portion of the said received second interfered EM pulse on a path (f) towards the further apparatus; the first portions of the respective first and second interfered EM pulses being associated with a path-encoded quantum cryptographic basis; f) output a second portion of the received second interfered EM pulse; the said second portion referred to as a second check pulse; C) the combined intensity of: i) the first portion of the first interfered EM pulse; and ii) the first portion of the second interfered EM pulse; that is output from the apparatus to the further apparatus comprises an average of up to one photon; IV) a second set of further optical elements configured to: h) receive the first and second check pulses; and, i) create spatially separated first, second and third sub portions of the first check pulse; and, j) create spatially separated first, second and third sub portions of the second check pulse; and, k) output the said sub portions in steps i) and j) for detection.

The fifth aspect may be adapted according to any teaching herein including but not limited to any one or more of the following.

The apparatus may further comprise an encoder configured to: i) receive the first portion of the first interfered EM pulse; ii) receive the first portion of the second interfered EM pulse; iii) change the path encoded quantum cryptographic basis to a different quantum cryptographic basis encoding.

The apparatus may be configured such that the encoder is configured to change a path-encoded quantum cryptographic basis to a polarisation-encoded cryptographic basis.

The apparatus may be configured such that the optical element (BS3) is a first optical element; the apparatus further comprising: I) a second optical element (BS1) for: i) receiving an EM pulse from a first set of two or more EM pulses; ii) receiving an EM pulse from a third set of two or more EM pulses; iii) interfering the two received EM pulses; iv) outputting the interfered EM pulse as the first EM pulse for inputting into the first optical element (BS1); II) a third optical element (BS2) for: I receiving an EM pulse from a second set of two or more EM pulses; ii) receiving an EM pulse from a fourth set of two or more EM pulses; iii) interfering the two received EM pulses; iv) outputting the interfered EM pulse as the second EM pulse for inputting into the first optical element.

The apparatus may be configured such that the first, second and third optical elements are integrated optical elements monolithically integrated to form a common device.

The apparatus may comprise of only EM pulse sources, EM detectors and passive, linear optical elements. Any of the aspects and examples herein may be adapted such that, passive, linear optical components may be used with other active components to perform the functions described by the passive, linear optical components, however performing such functions with just the passive components is preferred.

The is further presented a system comprising the apparatus of any of the previously described aspects and the further apparatus, wherein the further apparatus comprises: I) one or more optical components for measurement basis selection; II) one or more optical components for distinguishing states within the basis selected by (I); III) one or more EM detectors.

The apparatus of the second aspect may be configured such that the optical element is a first optical element (BS18); the apparatus further comprising optical components for measuring the phase difference between a first EM pulse and a second EM pulse.

### BRIEF DESCRIPTION OF THE DRAWINGS

Embodiments of the present invention will now be described in detail with reference to the accompanying drawings, in which:

FIG. 1 is a table describing an example QKD exchange using the BB84 protocol;

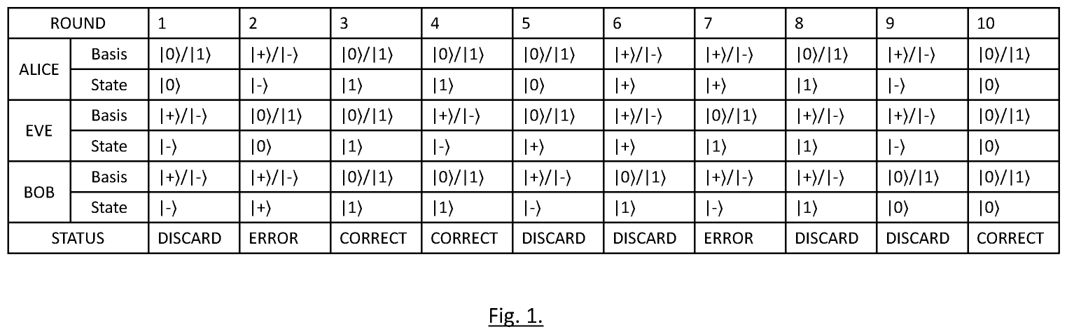

FIG. 2 is a schematic diagram of an example of a system using the apparatus for generating a quantum cryptographic key;

FIG. 3 is a schematic diagram of an example of an optical apparatus;

FIG. 4 is a schematic diagram of an example of a passive photonic chip;

FIG. 5 is a schematic diagram of an example of a passive photonic chip;

FIG. 6 is a graph with an example passive decoy state method;

FIG. 7 is a diagram of an example of encoding selection criteria;

FIG. 8 is a schematic diagram of a further example of a passive photonic chip;

FIG. 9 is a schematic diagram of a further example of an optical apparatus;

FIG. 10 is a schematic diagram of an example of a photonic chip with integrated lasers and detectors;

FIG. 11 is a schematic diagram of a further example of a passive photonic chip;

FIG. 12 is schematic diagram of an example of an implementation of a Phase Modulated (PM)-QKD protocol;

FIG. 13 is a schematic of an example of a basis selection diagram for a PM-QKD protocol;

FIG. 14 is a table showing example measurements in a PM-QKD protocol.

### DETAILED DESCRIPTION

In general, there is presented an apparatus for generating an interfered pulse to a further apparatus for the generation of a quantum cryptographic key. One or more electromagnetic pulse sources are utilised for outputting at least a first set of one or more (preferably two or more) EM pulses and a second set of one or more (preferably two or more) EM pulses. A random phase relationship exists between a first EM pulse and a second EM pulse. An optical element (BS3) receives the first EM pulse and the second EM pulse and is configured to interfere the first EM pulse with the second EM pulse and output an interfered EM pulse along an output path (preferably two or more output paths). At least one EM attenuator is configured to attenuate the said received EM pulse such that the attenuated EM pulse comprises an average of up to one photon. The attenuated pulse is output towards a further apparatus, for generating the quantum cryptographic key. The further apparatus may generate a QKD key using a passive receiver setup, for example using a beam splitter for basis selection and a polarising beam splitter and two detectors for each basis, or an active receiver setup, for example using a polarisation modulator for basis selection, followed by a polarising beam splitter and two detectors. A further step may be the post-selection of symbols at the receiver, depending on the properties of the generated pulse as measured at ALICE.

The transmitter may therefore be passive. In one example, where the transmitter ALICE measures symbols to determine whether they are close enough to an intended state′ the only new step in the receiver may be that many symbols will need to be left out, since Alice measured them to be not close enough to an intended state. The apparatus may be adapted according to any example herein.

There now follows examples of the apparatus and method. The apparatus and method are not limited to these examples and may be adapted according to other teaching herein, including but not limited to: the EM source types; the number of EM sources; the type and/or number and/or relative configuration of the optical couplers/splitters used to amplitude divide and/or interfere the pulses; the types and numbers of detectors; the type, number, length and relative positioning of optical paths used to propagate optical pulses or photons between different components such as sources, detectors, couplers and EM input/output components to/from the apparatus. In any of the examples, any of the sources and/or detectors and/or encoding components and/or attenuators may be integrated with the splitters (such as BS3 etc) by monolithic or hybrid integration or other forms of integration; alternatively, any of these components may be assembled together as a system, optionally in a package, such as a hermetic package. Optical pathways used to propagate light between different components may be any of integrated optics, bulk optics or optical fibres. One or more optical fibres may be included in the system for outputting EM signals to other systems such as one or more QKD detection systems. The system may be formed as a single device or a plurality of devices.

The QKD technique described in this patent has several characteristics which can be implemented in various ways. First the general characteristics are described, then various examples of how this technique can be implemented are described.

The QKD technique uses transmitter and receiver devices. One can either use a 2-device setup, with one transmitter, ALICE, and one receiver, BOB, or alternatively, one can use a 3-device setup with two transmitters, ALICE and BOB, and one receiver, CHARLIE. In both cases the secret key is generated between ALICE and BOB, with CHARLIE having no knowledge of the key in the second case.

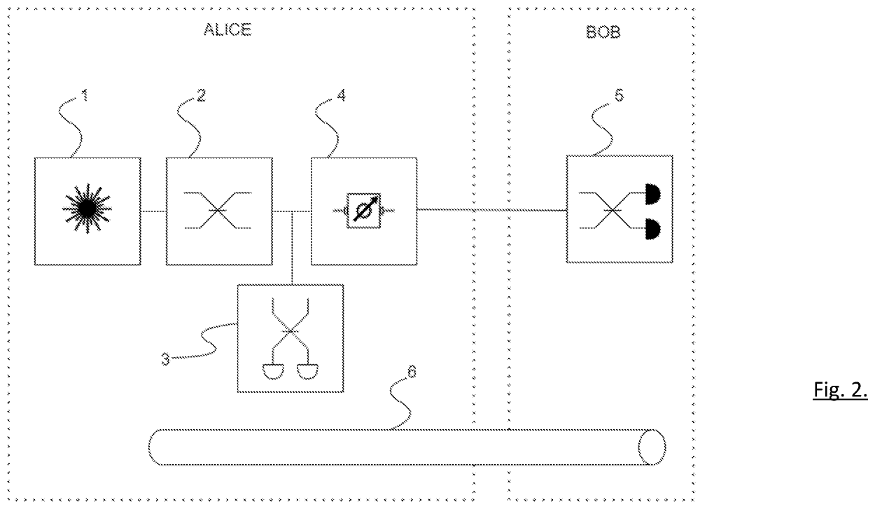

FIG. 2 shows a diagram of an example generic setup for the apparatus and methods described herein. The transmitter devices contain one or more electromagnetic (EM) pulse sources, labelled 1, which are pulsed in such a way that for each EM pulse source each pulse has a random phase relationship with respect to the previous and following pulses. Furthermore, the phases are uniformly distributed, such that the probability of a particular phase occurring for a particular pulse is the same as for any other phase. Additionally, pulses from different EM pulse sources have a random phase relationship with respect to each other as well. One way to create such pulses is to gain-switch lasers. In a gain-switched laser each pulse originates from a random decay moment creating a random phase for each pulse with respect to the previous pulse. Each created pulse contains a plurality of photons.

The EM pulses are of moderate intensity at most points inside the transmitter, such that it can be measured accurately with standard photodetectors, such as photodiodes. This intensity level may also be denoted as a classical intensity. The transmitted encoded symbol is only attenuated to single-photon level once the portion for measurement in the transmitter has been split off. This can be done for example using a linear optical attenuator or by tuning beam splitter ratios accordingly. The tuning can be done in the design stage and does not necessarily require an active photonic element. In a single-photon level pulse, the average photon number per symbol varies between 0 and 1, which means that the properties of quantum mechanics become relevant and measurement is subject to Heisenberg's Uncertainty Principle, i.e., measurement in non-orthogonal bases cannot be done accurately.

The EM source pulses, which have intrinsic random phase, are either used directly as encoded symbols in the QKD exchange, once attenuated to single photon level, or split, coupled and interfered using passive, linear optical devices to create differently encoded symbols before being attenuated. We will refer to this as passive encoding, which may include a passive decoy methodology. This is done in the section labelled 2 in FIG. 2.

Linear optical devices are taken here to mean any optical components whose operation is only based on linear optics, in other words the devices do not alter frequency of the EM pulse, allow application of the superposition principle and, apart from inherent loss, conserve photon number of a pulse. This is in contrast to non-linear devices, which are based on non-linear optics, such as crystals which facilitate second-harmonic generation. Passive linear optical devices are linear optical devices which are immutable during operation, in other words they are not adjustable during operation using outside signals such as electric currents.

One new step that may be required when using passive encoding, is measurement of the encoding of the created encoded pulse in the transmitter to create a record of the encoding at the transmitter. This measurement may be performed before the pulse is attenuated to single photon level, so a deterministic measurement can be done on the encoded pulse at classical intensity levels. For example, the measurement is done is the section labelled 3 in FIG. 2.

The other part of the pulse, the part that is not measured at Alice, is attenuated to single-photon level in the section labelled 4 in FIG. 2.

The order of sections 1-4 may be changed or elements of these sections may overlap. Not all sections may be required, dependent on the protocol that is implemented.

Dependent on the protocol used in the QKD exchange, not all passively encoded states may be usable and post-selection for valid states may need to be performed. For example, post-selection is used in the BB84 type protocols described below, but not in the PM-QKD protocol described below. Symbols that do not pass selection criteria are still sent from the transmitter to the receiver, but are not used for the actual creation of the final key. They could however still be used to gain statistical information on loss and error rates of the quantum channel.

Additionally, the passive encoding can be combined with a previously established technique. Such techniques may be those described in any one or more of the following references (1), (2), both of which are incorporated herein by reference:
(1) M. Curty, M. Jofre, V. Pruneri, and M. Mitchell, ‘Passive Decoy-State Quantum Key Distribution with Coherent Light’, Entropy, vol. 17, no. 6. MDPI AG, pp. 4064-4082 Jun. 12, 2015;
(2) M. Curty, X. Mₐ, B. Qi, and T. Moroder, ‘Passive decoy-state quantum key distribution with practical light sources’, Physical Review A, vol. 81, no. 2. American Physical Society (APS), Feb. 10, 2010.

Other references include:
(3) Shields, Andrew et al., 2017, An interference system and a method of fabricating an interference system, GB Patent GB2540589, filed 22 Jul. 2015, issued 25 Jan. 2017;
(4) Qin, Wang et al., 2018, Improved passive decoy state QKD (quantum key distribution) system based on attenuation laser light source, CH Patent CN107872316, filed 1 Sep. 2017, issued 3 Apr. 2018.

These references, particularly in (1) and (2) describe a method for passively creating decoy states in the transmitter, which only requires passive, linear optical elements, as described above, EM pulse sources and photodetectors, similarly to the encoding and measurement steps in the transmitter described here. The decoy state method is optional in QKD and can be left out if so required. These references, however, do not fully show how to encode a QKD state using only passive, linear optical components next to EM pulse sources and photodetectors. References (1), (3) and (4), only provide a method for passively creating a decoy state. (1) does not mention how to subsequently fully encode the QKD state. References (3) and (4) show methods for encoding the QKD state, however these methods require phase or polarisation modulators, which are active components. Reference (2) does show how to encode the QKD state using passive components, however it uses a non-linear component for this step. In the present application we show a method and apparatus to fully encode a QKD state that can optionally be implemented using only passive, linear optical components next to EM pulse sources and photodetectors.

Finally, for PM-QKD approaches, the need for active elements of phase stabilisation may be overcome with the use of reference pulses and measurement of interference of reference pulses and encoded pulses, and use of a modified encoding protocol. There is no optical phase locked loop or shared local oscillator between ALICE and BOB.

To summarise, with the exception of the EM pulse sources and the photodetectors, optical elements in the transmitters may be passive and linear. Randomness comes from the EM pulse sources, for example gain-switched lasers, which means that no (Q)RNG is required for the QKD system. The system may also work without active modulation of the symbols, which strongly reduces the complexity of the coordinating electronics.

The other sections in FIG. 2 are the receiver setup labelled 5 and the classical, authenticated channel that is needed for all classical communication in QKD protocols, labelled 6. The diagram in FIG. 2 is made for a 2-device setup. In a 3-device setup, ALICE and BOB would have the same elements, 1, 2, 3, 4, and 6, and CHARLIE would have elements 5 and 6 instead. The classical, authenticated channel should be between all parties: ALICE to BOB, ALICE to CHARLIE and BOB to CHARLIE.

The receiver requirements depend on the protocol used. For some protocols, for example for the BB84 protocols described below, standard receivers for the chosen encoding type may be used. For other protocols, the receiver side may need to be adjusted and a custom receiver should be designed. An example of this is the PM-QKD protocol described below.

Due to its simplicity, this QKD technique may be suitable for companies or organisations to build their own QKD systems. Though bulk optics and fibre optics can be used to implement the QKD technique described in this patent, due to the dependency on multiple interferometers, integrated optics is the most suitable, due to its excellent optical stability.

Optionally, the majority of the transmitter optical elements can be placed on an optical chip, especially the passive optical elements can be implemented in many different platforms, such as silicon on insulator, silicon nitrate or indium phosphide. With the wide range of platforms, a wide range of wavelengths can be utilised which is an advantage with respect to actively encoding QKD transmitters. The potential wavelength range may be at least from 400 nm to 4 um. Commonly used wavelengths in QKD are around 850 nm, for example 810-850 nm, for space QKD and around 1310 nm (also known as O-band: from 1260 to 1360 nm) or 1550 nm (also known as C-band: from 1530 to 1565 nm), for QKD using fibre channels.

Alternatively, this QKD technique is suitable for full chip scale integration, with lasers and photodiode detectors on the optical chip, which is possible with for example indium phosphide photonic chips, with simplified control electronics relative to current integrated QKD systems that use active encoding. A fully integrated optical device may restrict the wavelength, though commonly used wavelengths, especially the O- and C-band ranges, should still be easily accessible.

### Example for BB84

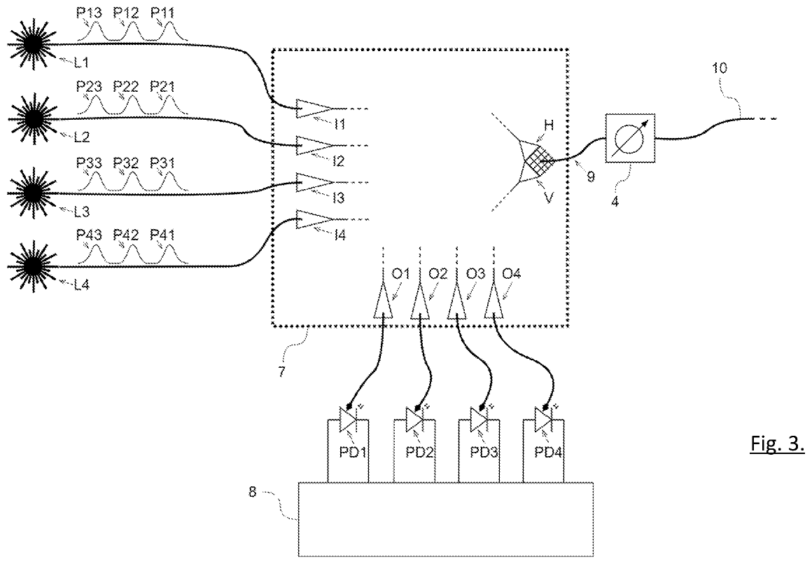

An example of an optical apparatus to create passively encoded QKD pulses with decoy states is shown in FIG. 3. The set-up comprises of four EM pulse sources, labelled L1, L2, L3 and L4, a passive photonic chip, labelled 7, a detection setup, labelled 8, an optical attenuator, labelled 4 and a connection towards the receiver BOB, labelled 10.

In this example, the EM pulse sources L1, L2, L3 and L4 are pulsed such that for each EM pulse source each pulse has a random phase relationship with respect to the previous and following pulses, EM pulses from one EM sources also have a random phase relationship with respect to EM pulses from another EM source and each individual EM pulse contains a plurality of photons.

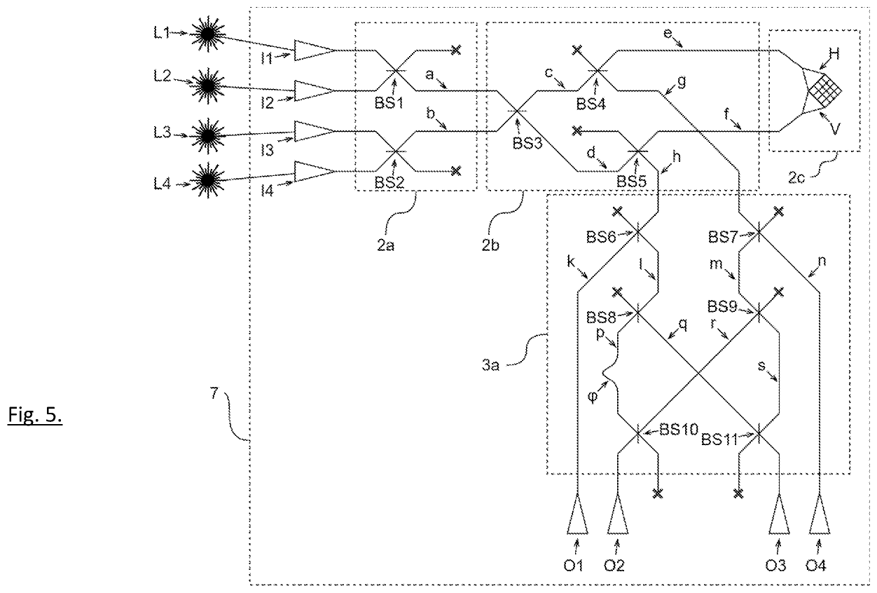

L1 creates a first set of one or more pulses, for example P11, P12, P13, and is coupled to input coupler I1 on the photonic chip. L2 creates a second set of one or more pulses, for example P21, P22, P23, and is coupled to input coupler I2 on the photonic chip. L3 creates a third set of one or more pulses, for example P31, P32, P33, and is coupled to input coupler I3 on the photonic chip. L4 creates a fourth set of one or more pulses, for example P11, P12, P13, and is coupled to input coupler I4 on the photonic chip. The photonic chip interferes these pulses such that an encoded state or set of encoded states is created. The first pulse from every set, for example P11, P21, P31 and P41, is used to create the first encoded state, the second pulse from every set, for example P12, P22, P32 and P42, to create the second encoded state, etcetera. Each encoded state is both measured in the transmitter apparatus and coupled off chip into the path labelled 9, which could, for example, be an optical fibre. An example layout of photonic chip, labelled with 7, can be found in FIG. 5. For measuring the state in the transmitter four photodiodes, labelled PD1, PD2, PD3 and PD4 are used. They are controlled and read out by detection electronics, indicated by label 8. They are coupled to the output couplers O1 to O4 on the photonic chip such that coupler O1 is coupled to PD1, O2 is coupled to PD2, O3 is coupled to PD3 and O4 is coupled to PD4.

A step before sending the encoded symbol from the transmitter ALICE to the receiver BOB is attenuation to single photon level, for example using an optical attenuator, labelled 4, or through earlier coupler output ratios, for example BS4 and BS5. The encoded symbol is then sent to BOB via the connection labelled 10.

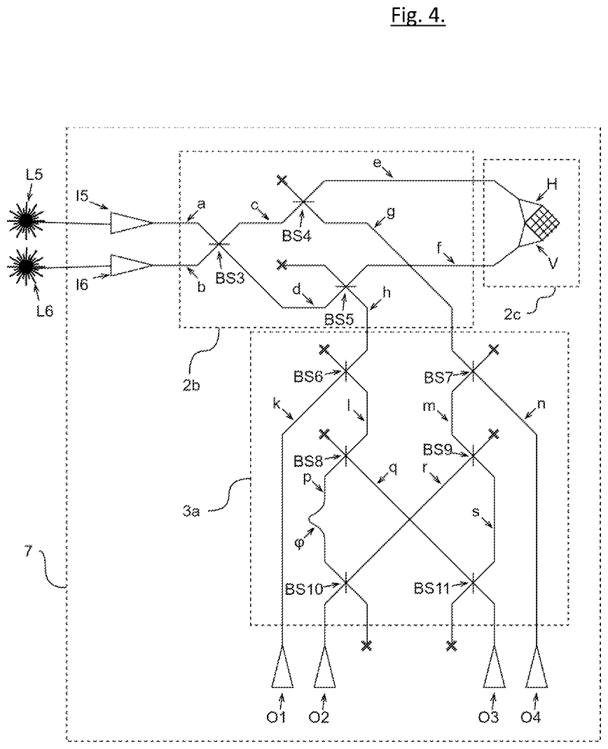

Optionally and alternatively, if no decoy method is required, only two lasers can be used, L5 and L6, with the same properties as L1 to L4 before, creating a first set of one or more pulses, for example P51, P52, P53 with L5 and a second set of one or more pulses P61, P62, P63 with L6. These are then coupled to an optical chip via input couplers I5 and I6 with the same properties as I1 to I4 before. An example layout of an optical chip to use in this case can be found in FIG. 4. The same measurement and attenuation elements are used as before.

The receiver device, at BOB, can be a standard BB84 receiver, the same as used for polarisation encoded BB84 with actively prepared states.

FIG. 4 shows an example of an optical chip that takes two EM pulses with random phase relationships as created by the EM pulse sources L5 and L6 and then, by interfering these pulses, creates a polarisation encoded state. The two EM pulses are coupled into the chip at couplers I5 and I6. These couplers I1 and I2 can be grating couplers, edge couplers or any other coupling type that can couple from free space or optical fibre to photonic waveguides on a photonics chip, or, if the lasers are on a separate optical chip, any couplers that couple from one chip to another could be used. For example, this could be using photonic wire bonds, butt coupling, flip-chip bonding or other methods.

The chip, indicated by label 7, can be divided into sections. The actual encoding of the QKD states is done in the section labelled 2b. In the section labelled 3a, the pulses are interfered such that the transmitter ALICE can read out the encoded state. Finally in the section labelled 2c, the on-chip path encoding is converted to polarisation encoding.

Though most of the encoding is done with EM pulses with a plurality of photons, such that classical optics applies, the final step before sending the encoded symbol from the transmitter to the receiver is attenuation to single photon level. In the alternative the attenuation may be accomplished at any point after a section of the pulses is split off for measurement at ALICE. For example between BS5 (and equivalently BS4) and section 2c. In principle, attenuation of one or both of the two signals forming the orthogonal polarisations of the polarisation encoded signal, can occur anywhere along the optical paths extending between: a) the couplers used to split light into signals for transmission to the other party (BOB) and signals to be measured at ALICE; and, b) the optical fibre or other transmission mechanism used to carry signals to BOB.

A further example of gaining the required attenuation is via the use of couplers: instead of adding linear optical attenuators, one could use couplers with such a ratio that the pulse output by the transmitter is single photon level. This can be done with BS4 and BS5 for example, where the ratio of these couplers may be such that most of the pulse is output towards section 3a, the measurement in the transmitter, i.e. into path g and h. Only enough of the pulse should be output towards paths e and f such that the encoded symbol output by the transmitter is at single photon level.

Furthermore, the apparatus may be configured such that the optical path length from:
a) the output of BS3, following optical paths c-e, to the input to the polarisation encoder 2c, is substantially the same as, preferably identical to;
b) the optical path length from the output of BS3, following optical paths d-f, to the input to the polarisation encoder 2c.

To encode a symbol an input EM pulse, for example P51, in the path labelled a, and an input EM pulse, for example P61, in the path labelled b, are interfered at on-chip coupler BS3. Looking at FIG. 4, due to the random phases from the input EM pulses from L5 and L6 the phase of the pulse in path a with respect to the phase of the pulse in path b is random, too. In FIG. 5, two EM pulses with random phase, for example P11 and P21, are interfered at BS1 creating a pulse with again random phase in path a. Another two EM pulses, for example P31 and P41, with random phase are interfered at BS2, creating another EM pulse with random phase in path b. From BS3 onward, the diagrams in FIGS. 4 and 5 are identical. BS3 can be any type of on-chip coupler that has at least two input paths and has at least two output paths such as 2×2 directional couplers or 2×2 multi-mode interferometers. Similar couplers may be used for other couplers (labelled BS) in this and any other examples.

The ratio of pulse intensity in the top and bottom output paths of BS3, path c and path d, respectively, is random, as well as the phase difference between the top and bottom output path. These two separate interference steps have created an encoding where: the phase difference between path c and path d is random; and the pulse intensity in path c is random with respect to the pulse intensity in path d. This type of encoding is called dual rail encoding, a type of path encoding.

Alternatively, one could have more than two output arms at BS3, for example by using a 2×3 multi-mode interferometer. This could be used, for example, when encoding states for use with QKD protocols that use three or more pulses per symbol, such as the differential phase shift QKD protocol.

Since the encoding is passively created, the encoded state in this example is measured in the transmitter to create a record of the symbol encoding that will be sent to the receiver (BOB). The measurement captures both the intensity of each path c and d and the relative phase difference between them. In order to measure at the transmitter, the pulse in both path c and path d is split, using on-chip coupler, BS4 and BS5 in the drawing, into a section that will be sent to the receiver BOB, paths e and f, respectively, and a section that is directed to the photodiodes in the transmitter, paths g and h, respectively. BS4 and BS5 can be any type of on-chip coupler that has at least one input path and has at least two output paths such as directional couplers, Y-couplers or multi-mode interferometers.

The detection setup in the transmitter consists of two input paths corresponding to the output paths g and h (each of which is an output path from splitter BS4 and BS5 respectively), which receive the section of the pulses split off as described above. Each input path g, h, is then connected to a respective on-chip coupler, denoted BS6 and BS7. One output path for each of these couplers, labelled k and n, respectively, is measured with off-chip photodiode PD1 and PD4, respectively, to which the photonic chip is coupled using output couplers O1 and O4, respectively, which allows the user to determine the pulse intensity in paths e and f. BS6 and BS7 can be any type of on-chip coupler that has at least one input path and has at least two output paths such as directional couplers, Y-couplers or multi-mode interferometers. Although the detectors O1-O4 are described as being off-chip, these detectors can be integrated with the chip.

To obtain the value of the phase difference between paths c and d, which is the same as the phase difference between paths e and f, the phase difference between paths g and h or the phase difference between paths l and m; the pulses in paths l and m are split at on-chip couplers BS8 and BS9, respectively. The outputs are interfered as follows: path p, which gains an additional phase ϕ, with path r at on-chip coupler BS10, path q with path s at on-chip coupler BS11. The apparatus may be configured such that the optical path length c-g-m-s, between BS3 and BS11, is substantially the same as or preferably identical to path lengths d-h-l-q, between BS3 and BS11. Furthermore, the apparatus may be configured such that the optical path length c-g-m-r, between BS3 and BS10, is substantially the same as or preferably identical to path lengths d-h-l-p, between BS3 and BS10, up to the path length difference giving rise to phase ϕ.

In this example, the additional phase ϕ is attained by having a longer optical path length between BS8-BS10 than BS9-BS10. The pulse intensity is then measured off-chip using photodiodes PD2 and PD3. One output path of BS10 is coupled to PD2 using output coupler O2. One output path of BS11 is coupled to PD3 using output coupler O3. These measurements, together with the measurements at PD1 and PD4 as described above, allow the user to reconstruct the phase difference between path e and path f.

BS8 and BS9 can be any type of on-chip coupler that has at least one input path and has at least two output paths such as directional couplers, Y-couplers or multi-mode interferometers. BS10 and BS11 can be any type of on-chip coupler that has at least two input paths and has at least one output path such as directional couplers, Y-couplers or multi-mode interferometers. Any of the splitters labelled ‘BS’ may intensity split light in any ratio, for example anywhere between 95/5-5/95; for example: 80/20; 20/80; 70/30; 30/70; 60/40-40/60; anywhere between 55/45 to 45/55; preferably 50/50.

The output couplers O1, O2, O3 and O4 can be grating couplers, edge couplers or any other coupling type that can couple from free space or optical fibre to photonic waveguides on a photonics chip. To prepare the final state sent to the receiver, the pulses in paths e and f are combined on a 2D coupling grating. This 2D coupling grating couples the EM pulses from one path to one polarisation orientation, denoted horizontal or H, and the EM pulses from the other path are coupled to the polarisation orientation orthogonal to the other polarisation orientation, denoted vertical or V. This converts the rail encoding to a polarisation encoding.

The polarisation encoding includes the state H, where all photons in the EM pulse is in the horizontal polarisation and the state V, where all photons in the EM pulse is in the vertical polarisation. The states H and V, in this example, form a basis for the BB84 QKD protocol. In other examples, other forms of encoding may be used by implementing other features, for example section 2c may be replaced by components for time bin encoding.

Additionally, there are combinations of H and V polarisations with a relative phase between them. Due to the interference steps only a subset of all combinations of relative intensity and relative phase are possible, dependent on the interferometer implementation. One such combination is the state where there are equal intensities or probabilities of H and V polarisation, and zero phase difference between them. This state is known as diagonal polarisation and is denoted D. The same intensities, but with a phase difference of n radians between H and V polarisations creates the anti-diagonal polarisation denoted A. The states D and A can form the second basis for the BB84 QKD protocol. It should be noted that these two bases are not exclusive, but different combinations of non-orthogonal bases could be chosen equivalently for different interferometer implementations.

While being optional, BB84 QKD using EM pulses often uses a decoy method. In the two above mentioned references by M. Curty, a passive decoy method is described which can be employed together with the passive encoding method described herein. This allows the use of a decoy method in the scheme described here without the need of active modulator elements. An example implementation of the passive encoding using the passive decoy method described in the two references can be found in FIG. 5. The example in FIG. 5 is similar to the example in FIG. 4 with like references referring to like components and any features and configurations and options provided with FIG. 4 equally may apply to FIG. 5. Instead of two EM pulse sources, now four EM pulse sources are used: L1, L2, L3 and L4. The four EM pulses are coupled into the chip at couplers I1, I2, I3 and I4. These couplers I1 to I4 can be grating couplers, edge couplers or any other coupling type that can couple from free space or optical fibre to photonic waveguides on a photonics chip.

In the section labelled 2a, a passive decoy method is implemented. The first interference steps are interfering the pulse coupled into I1 and the pulse coupled into I2 at on-chip coupler BS1 and interfering the pulse coupled into I3 and the pulse coupled into I4 at on-chip coupler BS2. BS1 and BS2 can be any type of on-chip coupler that has at least two input paths and has at least one output path such as directional couplers, Y-couplers or multi-mode interferometers. Since the phases of the input pulses are random and uniformly distributed, the intensity of the pulses in each output path of BS1 and BS2 is random and distributed over a wide range, as well. This step represents the implementation of a passive decoy state method. The total pulse intensity remaining varies between zero and the sum of all four input pulses. This total pulse intensity is the sum of the pulse intensity of one output path of BS1, denoted a, and the pulse intensity of one output path of BS2, denoted b. At following steps the total intensity will be redistributed over different paths, but the total intensity will only be subject to a constant attenuation factor from splitting the pulse intensities and potentially one or more attenuators (labelled 4 in FIG. 3) in subsequent steps. This constant attenuation factor of the total intensity is the same for every encoded symbol and is not dependent on the actual encoding.

For the actual encoding step one output of BS1, labelled a, and one of BS2, labelled b, is now chosen and interfered at on-chip coupler BS3. Due to the random phases from the input EM pulses from L1, L2, L3 and L4, the phase from the output of BS1 and the phase from the output of BS2 with respect to each other is random, too.

One option for creating the input pulses is by gain-switching four individual lasers, creating individual coherent states. These pulses are then passively interfered, split and attenuated which creates further coherent states, though when the light is sent from ALICE to BOB (label 10 in FIG. 3) the light intensity is less than one photon per encoded symbol. The same total attenuation is applied here in this example to every created state, which means that the variance in total intensity of path a plus path b is directly proportional to the variance of average photon number in the single photon level intensity pulse of the encoded symbol. This attenuation may be performed by a common optical intensity attenuator, a plurality of attenuators or other means, such as tuning coupler ratios.

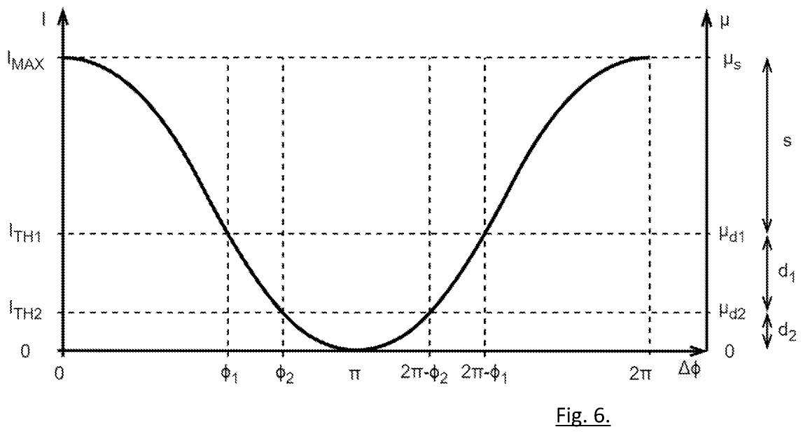

This variance of average photon number per encoded symbol is used in a passive decoy state method based on the references described above. One or more threshold values are set to separate signal and decoy states. FIG. 6 shows a graph of an example of such a decoy state method with two decoy levels. 0 is the lowest possible average photon number of the encoded symbol sent to the receiver. μₛ is the highest possible average photon number of the encoded symbol sent to the receiver. μ_{d1} is the threshold value between signal and decoy states and μ_{d2} is the threshold value between the higher and the lower decoy states. Then all states with an average photon number of 0 to μ_{d2} fall into the lower intensity decoy state d₂. All states with an average photon number of μ_{d2} to μ_{d1} fall into the higher decoy state d₁. All states with an average photon number of μ_{d1} to μₛ are designated as signal states. More decoy states can be added as required by adding further threshold values and therefore subdividing the average photon number interval of the decoy state. Decoy methods with only one decoy level can be created by for example removing threshold value μ_{d2}.

To determine the decoy level of the encoded symbol, ALICE may calculate the total intensity I of the EM pulses split off for her state determination measurement. There is a linear correlation between the total intensity measured at ALICE and the average photon number sent to BOB. Hence ALICE can set intensity thresholds corresponding to the average photon number thresholds of the passive decoy state method: I_{MAX} corresponds to μₛ, I_{TH1} to μ_{d1}, I_{TH2} to μ_{d2} and a 0 intensity corresponds to an average photon number of 0.

The variance in intensity originates from the interference at BS1 and BS2. At BS1, the phase difference Δϕ₁ between the EM pulse originating from I1 and the EM pulse originating from I2 determines the intensity going to path a. Similarly, at BS2, the phase difference Δϕ₂ between the EM pulse originating from I3 and the EM pulse originating from I4 determines the intensity going to path b. The variable Δϕ on the graph is a composite variable that depends on both of these phase differences Δϕ₁ and Δϕ₂, in other words we can write Δϕ(Δϕ₁, Δϕ₂).

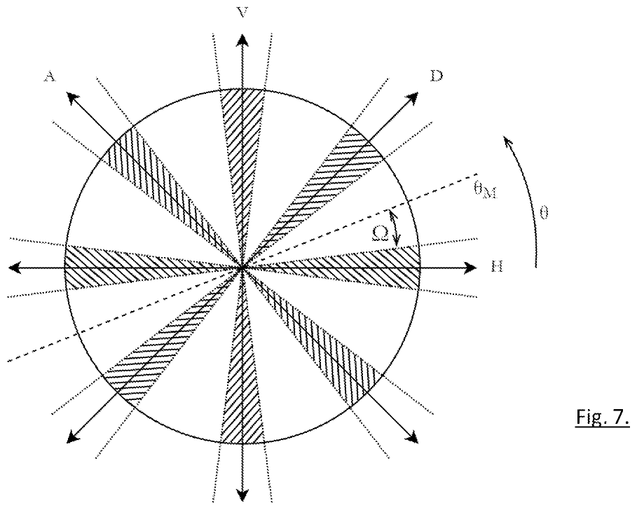

FIG. 7 illustrates an example for how the passively encoded states can map onto the standard BB84 states. The pure quantum states H, D, V and A represent states often used for polarisation encoded BB84. In this case H polarisation has angle θ=0, D has angle θ=π/4, V has angle θ=π/2 and A has angle θ=3π/4. Note that these are real angles, with θ representing the global angle orthogonal to the direction of movement of the pulse. This means that θ represents the same polarisation as θ+π.

Ignoring the varying total intensity of each encoded state, which is used solely for the decoy state method, and only looking at the relative intensity of H and V and the phase between the two, the states created in the passive encoding scheme fall distributed on a circular ring around the Bloch sphere. This is further understandable when looking at FIG. 4, since there is no decoy method implemented here. The same explanation also holds for an implementation with the decoy method described above, but in that case for the explanation of the encoding mapping onto BB84 in this section one should consider the total intensity of every state to be normalised, since the actual variance in total intensity only affects the decoy state methodology and not the encoding.

The Bloch sphere represents all possible states for a two-level quantum state and the ring is a restriction originating from the interference steps. Depending on the transmitter implementation, for example the actual chip design, this ring may fall differently on the Bloch sphere, but always includes the poles H and V in the case of polarisation encoding. In the case considered here, the ring includes the pure states H, D, V and A, which are the basis states, but also other pure states in between them. Other implementations may have a different second set of basis states, next to H and V. One can define an acceptance parameter Ω that defines how close a created state should be to a basis state to be used for the creation of the final secure key. A larger Ω represents a stricter selection, whereas a smaller Ω represents the situation where more states are used.

In the diagram, Ω is defined starting from the midpoint between H and D polarisation, labelled θ_{M}, towards H, however, the same value applies to all other states: each time measuring Ω from the midpoint between neighbouring states towards the state to obtain the range of excluded states.

The parameter θ can be calculated for every prepared state based on the measurement outcomes in the transmitter. As mentioned above, in this case θ represents the global angle of the EM wave with respect to its direction of movement. In other encoding types, such as time-bin encoding, a different parameter can be used, however, one can still apply the same principle of defining an acceptance parameter. When the value of θ calculated is too far from any of the basis states, with the threshold defined by Ω, the state is not used for key creation, otherwise it is used for key creation.

In the example in FIG. 7, one of the midpoint values is θ_{M}. An example of a θ that indicates a state that will be used for the key creation is 0<θ≤θ_{M}−Ω, where θ=0 represents the exact H polarisation. An example of a state that is not accepted for key creation is one where the value of θ is θ_{M}−Ω<θ<θ_{M}. Similar definitions are used with the other basis states and midpoints between them.

Apart from using a passive decoy state analysis method and including only the states that meet the acceptance criteria in the creation of the final key rate, one can use regular parameter estimation, error correction and privacy amplification steps for the BB84 method described above as with other BB84 versions. One can potentially also use the symbols that do not meet the acceptance criteria to calculate tighter bounds on the quantum channel properties. For example, the channel loss of the unused symbols should be the same as for the accepted symbols. However, this may require adaptation of standard parameter estimation methods.

Next to BB84, there exist other QKD protocols that use the exact same states and sometimes even the same quantum state exchange, one example being SARG04. These could use the same transmitters as described here for BB84. Therefore, the transmitter examples described herein may be suitable for BB84 and also for other similar protocols, possibly with minor adaptations.

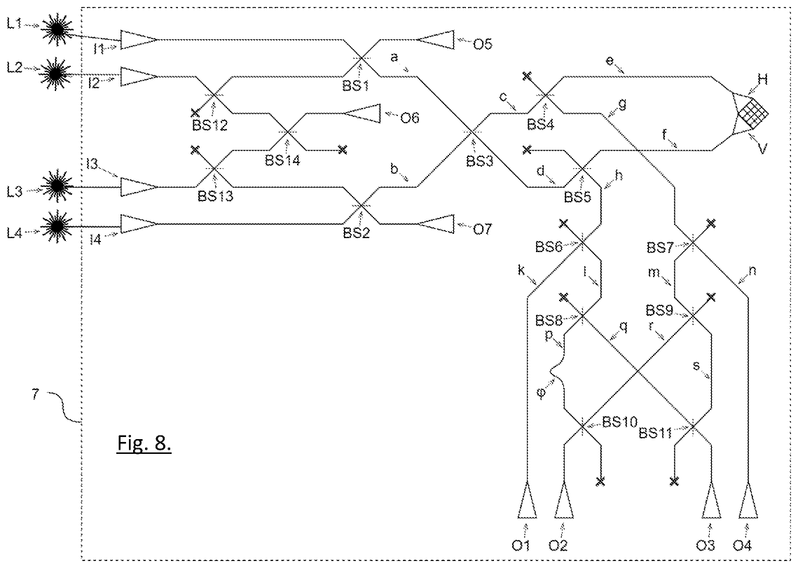

In FIG. 8 an example of a chip circuit diagram with further monitoring options can be found. FIG. 8 is similar to FIGS. 4 and 5 with like references representing like components and any features and configurations and options provided with FIG. 4/5 equally may apply to FIG. 8. In this example, the wavelength and timing of the four EM pulse sources are be controlled to ensure that the pulses have a good spectral and temporal overlap allowing high-visibility interference. To monitor the interference quality further monitoring options can be built into the chip. Interference between pulses originating from L1 and L2 (not shown in FIG. 8), which is done in the basic protocol regardless, is measured in the previously unused output path of BS1 which is coupled off chip to photodiode PD5 (not in figure) using output coupler O5. Similarly, the quality of the interference between pulses originating from L3 and L4 at BS2 is measured by photodiode PD7 (not in figure) for which output coupler O7 is used. Like other detectors described herein, these detectors may be integrated on the chip. One further data point is needed to have a reference linking all EM pulse sources, which is obtained by interfering EM pulses originating from L2 and L3. First, the EM pulse from L2 and the EM pulse from L3 is split with on-chip couplers BS12 and BS13, respectively. The split off pulses are then interfered at on-chip coupler BS14 and one output path of BS14 is coupled off chip using output coupler O6 and the pulse intensity is measured with photodiode PD6 (not in figure). PD5, PD6 and PD7 are also connected to the detection electronics.

BS12 and BS13 can be any type of on-chip coupler that has at least one input path and has at least two output paths such as directional couplers, Y-couplers or multi-mode interferometers. BS14 can be any type of on-chip coupler that has at least two input paths and has at least one output path such as directional couplers, Y-couplers or multi-mode interferometers. The output couplers O5, O6 and O7 can be grating couplers, edge couplers or any other coupling type that can couple from free space or optical fibre to photonic waveguides on a photonics chip.

To determine the quality of the interference, one can look for the maximum and minimum intensities measured at PD5, PD6 and PD7. Good interference will give the lowest minimum and the highest maximum intensity measurement, measuring multiple consecutive pulses, but measuring for every pulse time slot individually. In case the interference quality deteriorates, the EM pulse sources can be adjusted or tuned to restore interference quality.

Other than the addition of BS12, BS13, BS14, O5, O6 and O7, the chip circuit uses the exact same approach as the chip circuit in FIG. 5 described above.

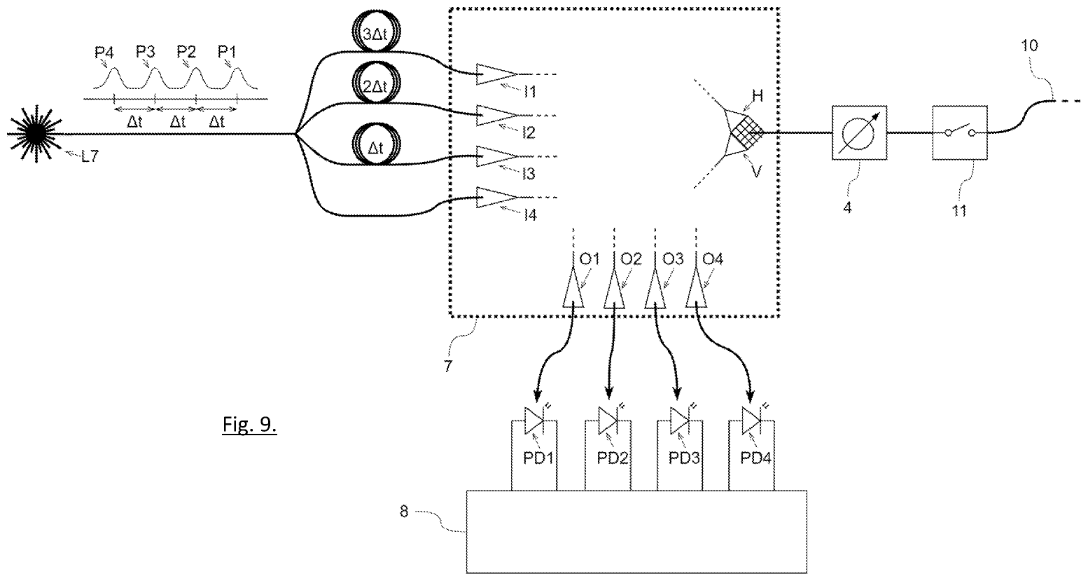

FIG. 9 shows another version of the transmitter design. Instead of using four EM pulse sources, as shown in FIG. 3, another version can be made using just one EM pulse source L7. In this case four consecutive EM pulses, separated by pulse period Δt are used to encode a single symbol. The first pulse in the sequence of four, is delayed three pulse periods, the second pulse is delayed two pulse periods and the third pulse is delayed one pulse period. After these delays the first pulse is input instead of L1 in FIG. 3, the 2nd pulse is input instead of L2, the third pulse instead of L3 and the fourth pulse instead of L4. The optical chip 7 used can be the same design as before, see FIG. 5 or 8, (wherein like references represent like components) and the rest of the protocol may be the same, too. In FIG. 9 there is shown the detection apparatus 8 for ALICE; the optional attenuator 4, a gating switch 11 and the output optical fibre 10 for carrying the EM signals to the receiver apparatus (not shown).

Though other setups could be used, for example with more active switches, FIG. 9 shows the option of delaying the pulses by passively splitting each pulse into four paths, with each path having zero, one, two or three pulse periods phase delay. Various splitters are suitable for this step, such as a 1×4 fibre optic couplers or three 1×2 fibre optic couplers, where the first 1×2 coupler splits the pulse into two, which then get split into two each again using the other two 1×2 couplers.

The disadvantage of this method is that four consecutive encoded symbols are correlated, since they use at least one of the same original EM pulses. Hence, optionally, at the output of the transmitter an extra optical switch 11 can be added to only let through every fourth encoded symbol.

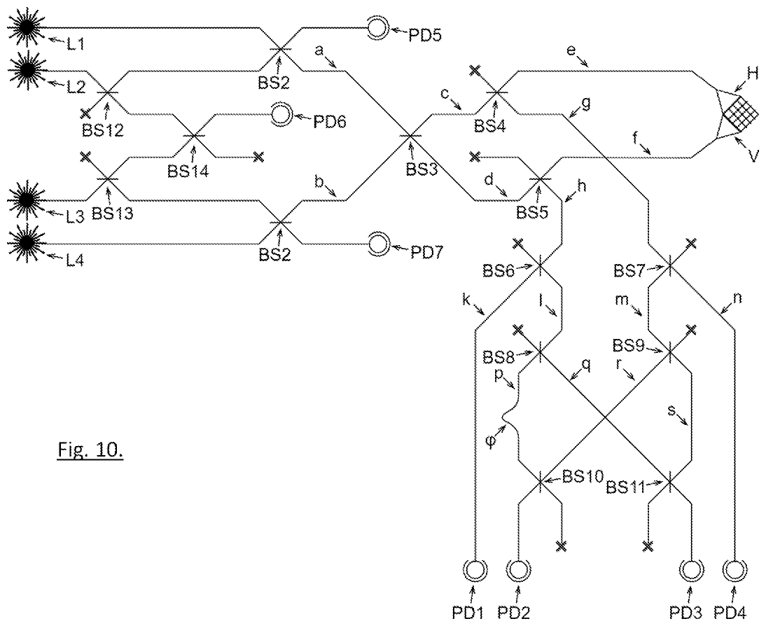

At the expense of the advantages of disaggregation and the security advantage, the transmitter can also be fully integrated on an optical chip. An example of a circuit diagram of such a chip is shown in FIG. 10. FIG. 10 is similar to FIGS. 4 and 5 with like references representing like components and any features and configurations and options provided with FIG. 4/5 equally may apply to FIG. 10.

In this case the chip will contain the EM pulse sources L1, L2, L3 and L4, which can be distributed feedback lasers for example, and photodiodes P1, P2, P3, P4, P5, P6 and P7 in addition to all previously used on-chip components. Photodiodes P5, P6 and P7 and on-chip couplers BS12, BS13 and BS14 are optional, but an interference quality monitoring system is highly beneficial to the quality of the encoding. Any control electronics and/or computers for a) receiving electrical signals from components such as photodetectors; b) inputting electrical signals for components such as sources L1-L4; for this example and other examples are not shown in the figures but may be part of the apparatus. Examples of computer hardware/software for use in controlling the apparatus; inputting/outputting electrical signal and analysing electrical signals are included elsewhere herein. These further electronic systems may be integrated into the chip or with the chip as an assembly or device that may be packaged.

Since EM pulse sources and photodiodes are active components, the chip will no longer be fully passive. In this example, the optical chip material may be chosen so it can provide the band gap for the wavelength at which the chip can operate. Additionally, dedicated electronics may be integrated onto the chip to control the pulse source/s and read out the photodiodes which are connected to the chip via, for example, wire bonds. However, with a fully integrated optical chip come advantages such as a lower cost at high volume manufacturing, a smaller footprint of the full transmitter and additional optical stability. The source set-up of FIG. 9 may be used with this example.

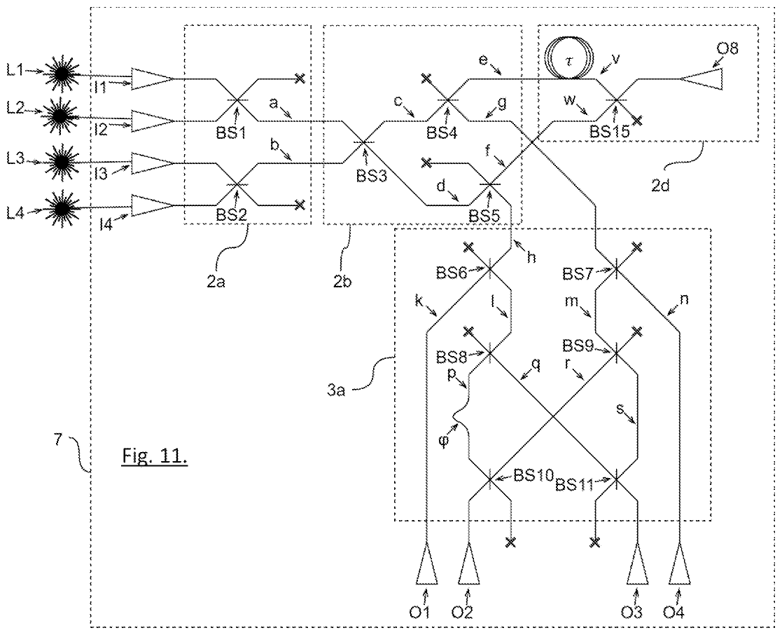

FIG. 11 shows a further alternative chip circuit diagram, showing an alternative to polarisation encoding. FIG. 11 has some similar components to FIGS. 4 and 5 and other examples, with like references representing like components. Any features and configurations and options provided with other examples may optionally apply to FIG. 11.

There are various other ways to encode states in the BB84 protocol which one could convert to from the on-chip path encoding. One such encoding uses time bins and relative phase and is known as time-bin encoding.

A symbol contains two time-bins, instead of just a single pulse. One measurement basis is formed from the distribution of pulse intensity over the two time bins, with the first state in the basis having all light in the first time bin, denoted |0 [symbol] and the second state in the basis having all light in the second time bin, denoted |1 [symbol] . The second basis uses the relative phase of the pulses in the two time-bins, provided both time bins have an equal light intensity. In the first state, denoted |+ [symbol] , pulses in both time-bins are in phase, i.e. 0 phase difference between time bins. The second state has exactly π phase difference between the two time-bins, which again have the same pulse intensity, and is denoted |− [symbol] .

This encoding can be approximated, again using post-selection, with a very similar method to the polarisation encoded BB84 version described above, with the following adaptations, found in box 2d:
1. Path v is delayed by τ with respect to path w to create two time-bins. Thus, optical path c-v may be longer than path d-w.
2. The 2D grating from the polarisation method is replaced by an on-chip coupler, labelled BS15, and an output coupler O8. Delayed path v and path w are recombined at BS15. The pulses do not interfere here, since the pulse from path w is now in time-bin one and the pulse from path v is now in time-bin two. One output path of BS15 is then coupled off chip and into a fibre or free space.

BS15 can be any type of on-chip coupler that has at least two input arms and has at least one output arm such as directional couplers, Y-couplers or multi-mode interferometers. The output coupler O8 can be a grating coupler, edge coupler or any other coupling type that can couple from free space or optical fibre to photonic waveguides on a photonics chip.

Afterwards the light is treated in the same manner as for the polarisation encoded version and attenuated to single-photon level before being sent off to the receiver. Similarly, to the other examples, the attenuation can also be accomplished through other means, for example through selecting the right coupling ratios at BS4 and BS5. The criteria for acceptance of the state are now defined differently, though the same principle applies. Acceptance criteria are dependent on both the relative intensity in each path, for both bases, and the relative phase between paths, in the case of the basis using the |+ [symbol] and |− [symbol] basis states.

At the receiver a standard BB84 receiver for time-bin encoding can be used. Otherwise, the protocol uses the same methodology as the polarisation encoded method described above.

### Phase Matched Example

Phase matched QKD is a 3-party protocol, involving ALICE, BOB and CHARLIE. ALICE and BOB generate a key between each other, while CHARLIE is untrusted node in the middle. The two transmitter nodes, ALICE and BOB exchange a key by encoding information on EM pulses and transmitting them to CHARLIE the receiver node. Traditionally, ALICE and BOB consist of a pulsed EM source and phase modulators used to encode information upon the pulses. CHARLIE traditionally consists of a beam splitter and two single photon detectors (SPDs). CHARLIE's role is to interfere the pulses and measure the interference.

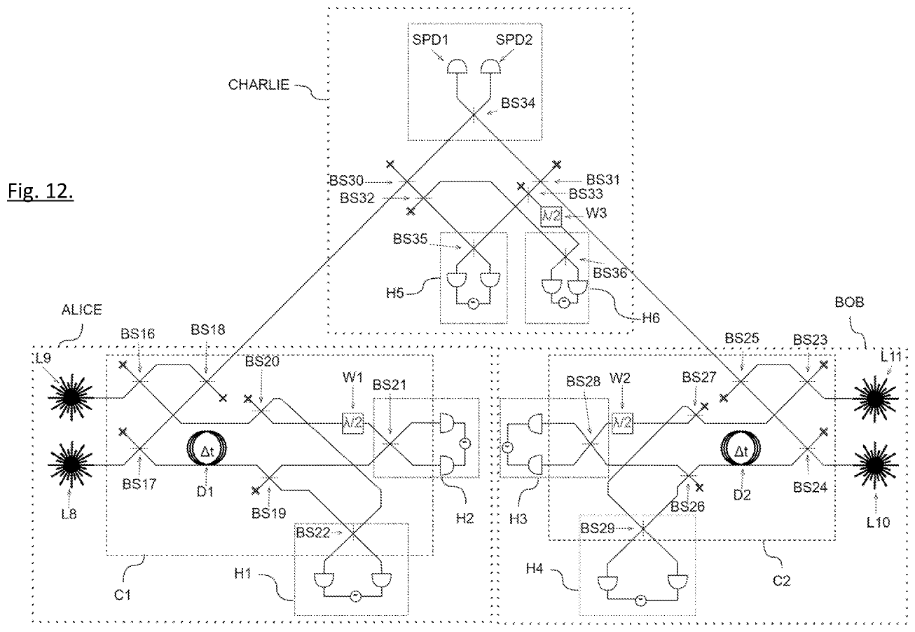

FIG. 12 shows an example implementation of a phase matched quantum key distribution protocol, where ALICE and BOB send symbols to a central node CHARLIE. For the protocol ALICE and BOB transmit coherent states with random phases to CHARLIE, who interferes them and announces the measurement result, using this and knowledge of their own symbol, ALICE and BOB can determine the phase of the other party's symbol and therefore generate a secret key.

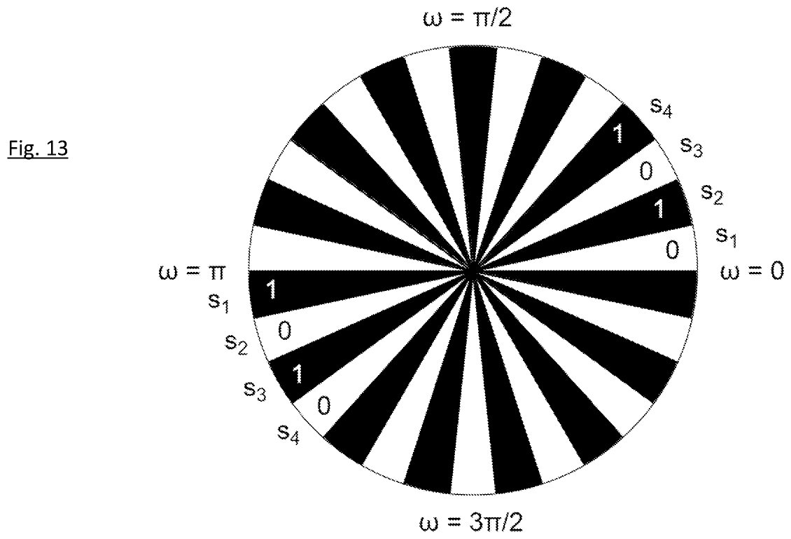

A passive implementation of the PM-QKD requires a modification to the protocol ALICE and BOB to pre-share a phase diagram, an example of one is shown in FIG. 13, which determines the basis segments within the encoding phase range of 0 to 2π. Each opposing pair corresponds to a basis, with a 0 and 1 key bit being allocated to one of the two segments. It also requires the passive creation of signal pulses to perform QKD, and reference pulses, which are used to determine a global phase relationship between ALICE and BOB, as well as to act as local oscillators (LOs) to perform the heterodyne detection of the signal pulses.

The heterodyne detection arrangement may be formed of two or more homodyne detector arrangements wherein each homodyne detector arrangement comprise an EM splitter for receiving EM pulses from at least two different optical paths and directing a portion of EM signals from each path into two (or more) EM detectors. In FIG. 12 the homodyne detector arrangements comprise a 2×2 port coupler optically linked to two separate EM detectors that output corresponding electrical signals to common homodyne electronics. A heterodyne detection system may comprise two such homodyne arrangement wherein: a) a portion of an input EM pulse from each of BOB and ALICE are input into the first homodyne arrangement; b) a further portion of the same input EM pulse from each of BOB and ALICE are input into the second homodyne arrangement.

The system shown in FIG. 12 comprises ALICE, BOB and CHARLIE. ALICE consists of 2 EM pulsed sources L8 and L9, a passive integrated photonic chip C1, a heterodyne detector comprised of 2 heterodyne detectors H1, H2, and phase shift W1. Similarly, BOB consists of EM pulsed sources L10 and L11, a passive integrated photonic chip C2, and a heterodyne detector composed of heterodyne detectors H3, H4 and phase shift W2. CHARLIE consists of a heterodyne detector composed of heterodyne detectors H5, H6 and phase shift W3, passive optics i.e. beam splitters BS30, BS31, BS32, BS33, BS34 and two single photon detectors SPD1 and SPD2.

Reference pulses are produced by L8 at ALICE and by L10 at BOB. The signal pulses are produced by L9 at ALICE, and by L11 at BOB. In the protocol described, each transmission block includes a single reference pulse and a single signal pulse, however an arbitrary amount of signal pulses can be sent. Typical transmission rates of the pulsed sources could be between, 10 Mhz-10 Ghz. An arbitrary transmission rate could be used provided it is sufficiently high to ensure the phase drift of the transmission channels between ALICE and CHARLIE, and BOB and CHARLIE is negligible between the transmission of reference pulse and all signal pulses in the transmission block.

In the implementation in FIGS. 12 L8 and L9 are coupled into a photonic chip, C1 at ALICE, and L10 and L11 are coupled into a photonic chip C2 at BOB. The coupling methods can be the same as mentioned previously in other examples. Alternative implementations could have the sources integrated on chip, or could be injected into a bulk optics circuit.

L8 produces a pulse which is split into two pulses |αᵣₐ₁ [symbol] and |αᵣₐ₂ [symbol] on a beamsplitting element BS17. L10 produces a pulse which is split into two pulses |α_{rb1} [symbol] and |α_{rb2} [symbol] on beamsplitting element BS24. After BS17 |α_{rb1} [symbol] is transmitted to CHARLIE via BS18 and is incident on BS30. BS18s purpose is to allow pulses from both L8 and L9 to be transmitted to CHARLIE via the same spatial mode. In a similar fashion as for ALICE, after BS24 |α_{rb2} [symbol] is transmitted to CHARLIE via BS25 and incident on BS31. The transmissivity/reflectivity ratios of BS30 and BS31 are optimised such that most of the light goes to the output port leading to the single photon detection stage, while a small portion goes to a heterodyne detection stage. The purpose of this is to allow the signal pulses to be detected by the single photon detectors efficiently, while also letting the reference pulses to be detected by the heterodyne detection stage. The ratios may be tuned so the reference pulses do not damage the SPDs, and can be correctly detected by the heterodyne stage, while simultaneously not causing too much attenuation of the quantum signal. Additionally, the ratios may be actively controlled to ensure the that the signal pulses are detected by the single photon detectors and that the reference pulses are detected by the heterodyne detectors.

The heterodyne detection stage is comprised of beam splitters BS32, BS33, a phase delay W3 and two heterodyne detectors, H5 H6. The measurement of the interference of the reference pulses at H5 and H6 is recorded, and the relative phase of the two pulses after having travelled down the fibre channel is calculated. Denoted by M₁, this is phase is then publicly announced to all parties.

|αᵣₐ₁ [symbol] and |α_{rb1} [symbol] get sent into delay lines D1, and D2 respectively, to be used as local oscillators for a heterodyne measurement and interfered locally with the signal pulses from L9 and L11. These measurements along with M₁ will allow ALICE and BOB to determine the phase of their signal pulses relative to the same global phase as will be shown later.

L9 generates a pulse |αₛₐ [symbol] with random phase ωₐ, to be used as the QKD signal. It is split on beamsplitter BS16 into pulses |αₛₐ₁ [symbol] and |αₛₐ₂ [symbol] . L11 generates a pulse |α_{sb} [symbol] with random phase ω_{b}, which is split on beamsplitter BS23 into pulses |α_{sb1} [symbol] and |α_{sb2} [symbol] . It is necessary for ALICE and BOB to know the relative phases of their states before transmitting them. Therefore, a heterodyne detection is performed on |αₛₐ₁ [symbol] . To do this it is split on another beamsplitter BS20 the two outputs are sent to heterodyne detectors H1 and H2. The portion of the pulse travelling towards the heterodyne detection stage |αₛₐ₁ [symbol] should be sufficiently bright to be considered classical for the detection to be accurate. The other portion |αₛₐ₂ [symbol] should be attenuated to single photon level before being transmitted to Charlie. This can be achieved in a number of ways. In the way shown in FIG. 12, the splitting ratio of BS16 is such that most of the light travels towards BS20 to make the heterodyne detection efficient, while simultaneously attenuating the light going to BS18 to single photon level. Alternatively, instead of tuning the splitting ratio of BS16, an attenuating element could be inserted between beamsplitters BS16 and BS18. Or BS18 could be tuned to be only transmit a small portion of light towards Charlie, from the input port input port connected to BS16. Or an active attenuator could be inserted at the output of BS18 which is actively switched on to coincide with the arrival of pulse |αₛₐ₂ [symbol] , but switched off otherwise so as to not attenuate |αᵣₐ₂ [symbol] . |αᵣₐ₁ [symbol] is sent to BS19 and split into two, and also sent to heterodyne detectors H1 and H2 to act as the local oscillator in the detection. Detector W1 introduces a phase shift of π/2 to the arm of the signal before H2 to measure a different quadrature of the signal pulse. The measurements from H1 and H2 are recorded, and the calculated phase of the state is αₛₐ saved as Mₐ.

In a similar fashion at BOB, |α_{sb1} [symbol] is bright, and |α_{sb2} [symbol] is attenuated to single photon level. In FIG. 12 BS23 is tuned so that most of the light from L11 gets sent towards BS27. |α_{sb1} [symbol] gets split on beam splitter BS27 the two outputs and sent to Heterodyne detectors H3 and H4 to perform heterodyne detection. |α_{rb1} [symbol] is split on BS26 and sent to H3 and H4. There is a phase shift π/2 via W2 on the signal branch of the input to H3. The measurements from H3 and H4 are recorded, and the calculated phase of the state is |α_{sb} [symbol] is saved as M_{b}.

One pulse from ALICE, |αₛₐ₂ [symbol] , and one pulse from BOB |α_{sb2} [symbol] , are sent to CHARLIE to be interfered to perform QKD. |αₛₐ₂ [symbol] passes through BS18 before reaching BS30. At this point the bit of interest is the part of the pulse which travels to BS34. BOB's pulse |α_{sb2} [symbol] transmits to CHARLIE via BS25 to BS31. Again, the part of interest is the part of the pulse which travels to BS34 where it interferes with ALICEs pulse |αₛₐ₂ [symbol] . Finally, the interference is detected using the single photon detectors SPD1 and SPD2. The resultant measurement is a quantum projection of phase onto 0, and π, depending on whether SPD1 or SPD2 detects a photon. The resulting measurement is labelled M₂ and publicly announced.

As the transmission rate of the lasers may be set sufficiently high on the order of 10 MHz-10 GHz such that the channel phase drift between ALICE and CHARLIE, and BOB and CHARLIE, is negligible between the transmission of the reference pulses to CHARLIE and the signal pulses to CHARLIE. The relative phase of ALICE's state ωₐ can then be taken to be ωₐ=Mₐ and BOB's signal state ω_{b}=M_{b}−M₁, where both are taken against the same reference phase of Rₐ+Cₐ. Where Cₐ is the phase added by the channel between ALICE and CHARLIE. This phase Cₐ is assumed to be kept constant between all the measurements of a given transmission block.

From this point onward, ALICE and BOB know the phase of their states in a commonly known reference frame. They then publicly share which pair of basis segments their phases lie within. And sift for occasions where they coincide. Depending on the result of M₂ ALICE and BOB can infer whether they sent a phase in the same segment or opposing segments. If SPD1 clicks, i.e. detects a photon, then both BOB and ALICE keep their bit as they sent the same phase, if SDP2 clicks, then BOB flips his bit to match ALICE's, as this represents a n phase difference. ALICE and BOB perform parameter estimation, error correction and privacy amplification steps as with other PM-QKD protocols.

The phase relationships between all the pulses can be demonstrated in the following way:

The phases of ALICE's and BOB's reference pulses are Rₐ, and R_{b}.

The phases of ALICE's and BOB's signal pulses are ωₐ and ω_{b}.

The phases introduced by the fibre channel between ALICE and CHARLIE, and between BOB and CHARLIE are Cₐ and C_{b}.

In total there are 4 phase measurements.

The first three are heterodyne measurements which give a continuous value of phase.

Measurement 4 is the quantum projection which will give a binary result of 0 or π.

$${M}_{1} = ( {R}_{b} + {C}_{b} ) - ( {R}_{a} + {C}_{a} ) \qquad 1 )$$

$${M}_{a} = {R}_{a} - {ω}_{a} \qquad 2 )$$

$${M}_{b} = {R}_{b} - {ω}_{b} \qquad 3 )$$

$${M}_{2} = ( {ω}_{b} + {C}_{b} ) - ( {ω}_{a} + {C}_{a} ) \qquad 4 )$$

The phase of ALICE's reference pulse when it arrives at CHARLIE is: Rₐ+Cₐ

The phase of the ALICE's signal pulse as it arrives at CHARLIE, relative to our global reference is:

$$( {R}_{a} + {C}_{a} ) - ( {φ}_{a} + {C}_{a} ) = {R}_{a} - {ω}_{a} = {M}_{a}$$

Rearranging equation 1) Rₐ=R_{b}+C_{b}−Cₐ−M₁

BOB's signal pulse arrives at CHARLIE relative to our global reference:

$${R}_{a} + {C}_{a} - ( {ω}_{b} + {C}_{b} ) = {R}_{b} + {C}_{b} - {C}_{a} - {M}_{1} + {C}_{a} - {ω}_{b} - {C}_{b} = {R}_{b} - {ω}_{b} - {M}_{1} = {M}_{b} - {M}_{1}$$

We shall call the phase received at CHARLIE from Alice in our global reference frame, Sₐ and the phase from BOB S_{b}.

$${S}_{a} = {M}_{a} and {S}_{b} = {M}_{b} - {M}_{1}$$

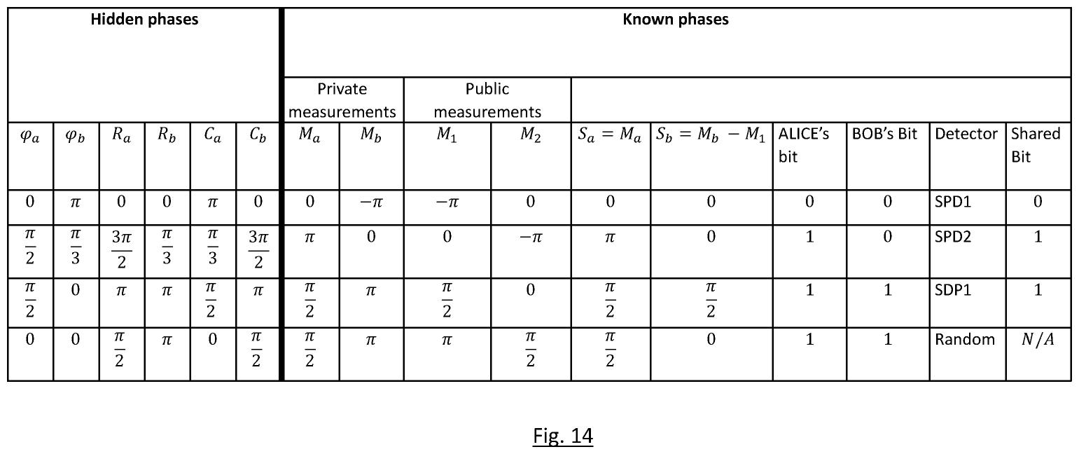

The table in FIG. 14 shows some example measurements. The right hand side of the table from M₁, are what the participants have access to at the end of a single QKD bit exchange. The left hand side of the table, are one set of possible phases which could produce the measurement results shown.

Mₐ and M_{b} are private measurements only known to ALICE and BOB respectively. These are used to calculate Sₐ and S_{b} which represent the phases upon which ALICE and BOB have encoded.

M₁ is a public measurement required to calculate Sp. Which detector clicks is determined by the value of M₂. If M₂ is 0 then SP1 clicks, if it's π, then SPD2 clicks. If M₂ lies in between 0 and π there will be a proportional probability of either SPD1 or SPD2 clicking. If ALICE and BOB lie within the same basis, then this result tells them whether they have 0 or π phase difference between them, and whether or not they have the same bit, or opposite bits. This information is also given by Sₐ and S_{b}, when they are the same and SPD1 clicks, if they are opposite phases SPD2 will click.

The exact bit for a given phase, will depend on the preshared phase diagram. If they have opposite bits, BOB flips his. If they don't lie in the same basis, then the measurement outcome is random, and they cannot deduce a shared bit. They know if they are in the same basis by publicly stating which basis section they were in on the phase diagram, at the end of the transmission. This step is known as sifting.

Row 1 in the table shows an example where ALICE and BOB both encode 0s within the same basis and correctly deduce a share bit of 0. Row 2 in the table shows an example where ALICE encodes a 1 and BOB encodes a 0 in the same basis, and they manage to deduce a shared bit of 1. Row 3 in the table shows where ALICE and BOB both encode a shared 1 in the same basis and deduce a shared bit of a 1. Row 4 in the table shows an example where ALICE and BOB send bits in different bases and therefore can't deduce a shared bit.

Row 1 in the table shows an example where ALICE measures 0 for Mₐ and BOB measurements −π for M_{b}. Then the public measurement for M₁ is −π. Using this Sₐ and S_{b} are calculated locally as 0 and 0. This transmission can be used to deduce a key, because Sₐ and S_{b} lie in the same phase basis. M₂=0, therefore it is publicly announced that SPD1 clicked. Then Alice and Bob publicly announce their bases and find out this transmission can be used. Alice knows she sent 0 and Bob knows he sent 0. M₂ tells them the phase difference between their states was 0, so Bob knows to keep his bit. The table also gives an example of phases, φₐ, φ_{b}, Rₐ, R_{b}, Cₐ and C_{b} which could produce the above measurement results. But these are never known during the key exchange.

Row 2. In the table shows an example where ALICE measures π for Mₐ, BOB measures π for M_{b}. M₁ is announced as 0. This lets ALICE and BOB calculate Sₐ and S_{b} as π, and 0. Sₐ and S_{b} lie in the same basis as there is a π phase difference between them and this exchange can also be used. M₂ is publicly announced as −π. After sifting, Bob knows there is a π phase difference between his and Alices state, from the result of measurement M₂ and therefore knows to flip his bit.

Row 4 shows an example where ALICE measures π/2 for Mₐ, BOB measures π for M_{b}. M₁ is announced as π. This lets ALICE and BOB calculate Sₐ and S_{b} as π/2, and 0. Sₐ Sₐ and S_{b} don't lie in the same basis so this exchange will not be used. When calculating M₂ the result is π/2, this means half the time SPD1 will click and half the SPD2 will click. After sifting, ALICE and BOB know the outcome of the detector clicks is random and a shared bit can not be deduced.

It is worth noting that all the basis sections have a finite width as with the original PM-QKD protocol, meaning that ALICE and BOB's phases may not have an exact 0 or π phase shift, but be close enough to these values to be within a basis pair and still be acceptable for doing QKD. As long as the phases lie within the same basis segment there is only a small chance the wrong detector clicks during the M₂ measurement. The basis widths are optimised to trade off increasing the chance of an error during the M₂ measurement, while still having a high enough proportion of symbols which coincide within the same basis pair compared to those that don't.

Passive decoy state generation could be added to the state preparation of the PM-QKD implementation for both ALICE and BOB's states, in a similar fashion as described in previous examples. This would allow the implementation of a Twin Field QKD like protocol with decoy states.

As with the BB84 implementations, rather than using multiple lasers L8, L9 at ALICE and L10,11 at BOB, a single laser maybe be multiplexed using an active switch at each transmitter.

Examples of Computer Apparatus for Use with the Examples

Some portions of the above description present the features of the invention in terms of steps to perform. These may be performed using an algorithm or otherwise operations on information. These algorithmic descriptions and representations are the means used by those skilled in the data processing arts to most effectively convey the substance of their work to others skilled in the art. These operations, while described functionally or logically, may be understood to be implemented by computer programs.

Unless specifically stated otherwise as apparent from the description above, it is appreciated that throughout the description, discussions utilising terms such as “processing” or “identifying” or “determining” or “displaying” or the like, may refer to the action and processes of a computer system, or similar electronic computing device, that manipulates and transforms data represented as physical (electronic) quantities within the computer system memories or registers or other such information storage, transmission or display devices.

It should be understood that the process steps, instructions, of the said method/system as described and claimed, may be executed by computer hardware operating under program control, and not mental steps performed by a human. Similarly, all of the types of data described and claimed may be stored in a computer readable storage medium operated by a computer system, and may not simply disembodied abstract ideas.

Any computation apparatus/system for use with the apparatus may be specially constructed for the required purposes, or it may comprise a general-purpose computer selectively activated or reconfigured by a computer program stored on a computer readable medium that can be executed by the computer. Such a computer program is stored in a computer readable storage medium, such as, but not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each coupled to a computer system bus.

Furthermore, the computers referred to in the specification may include a single processor or may be architectures employing multiple processor designs for increased computing capability.

Any controller(s) referred to above may take any suitable form. For instance, the controller(s) may comprise processing circuitry, including the one or more processors, and the memory devices comprising a single memory unit or a plurality of memory units. The memory devices may store computer program instructions that, when loaded into processing circuitry, control the operation of the route provider and/or route requester. The computer program instructions may provide the logic and routines that enable the apparatus to perform the functionality described above. The computer program instructions may arrive at the apparatus via an electromagnetic carrier signal or be copied from a physical entity such as a computer program product, a non-volatile electronic memory device (e.g., flash memory) or a record medium such as a CD-ROM or DVD. Typically, the processor(s) of the controller(s) may be coupled to both volatile memory and non-volatile memory. The computer program is stored in the non-volatile memory and may be executed by the processor(s) using the volatile memory for temporary storage of data or data and instructions. Examples of volatile memory include RAM, DRAM, SDRAM etc. Examples of non-volatile memory include ROM, PROM, EEPROM, flash memory, optical storage, magnetic storage, etc. The terms ‘memory’, ‘memory medium’ and ‘storage medium’ when used in this specification are intended to relate primarily to memory comprising both non-volatile memory and volatile memory unless the context implies otherwise, although the terms may also cover one or more volatile memories only, one or more non-volatile memories only, or one or more volatile memories and one or more non-volatile memories.

The algorithms and operations presented herein can be executed by any type or brand of computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the method/system is not described with reference to any particular programming language. It is appreciated that a variety of programming languages may be used to implement the teachings of the invention as described herein.

1. An apparatus for generating one or more interfered pulses for outputting to a further apparatus for the generation of a quantum cryptographic key; the apparatus comprising:
I) one or more electromagnetic, EM, pulse sources for outputting at least a first set of one or more EM pulses and a second set of one or more EM pulses; wherein
at least a first EM pulse is based from at least one of the first set of EM pulses; and,
at least a second EM pulse is based from at least one of the second set of EM pulses;
wherein:
a) a random phase relationship exists between the first EM pulse and the second EM pulse;
b) each of the first and second EM pulses comprises a plurality of photons;
II) an optical element (BS3) comprising:
c) a first input path (a) for receiving the first EM pulse;
d) a second input path (b) for receiving the second EM pulse;
e) at least one output path (c, d);
wherein:
the first input path (a) is spatially separate to the second input path (b);
the optical element (BS3) is configured to
interfere the first EM pulse with the second EM pulse;
output an interfered EM pulse along the at least one output path (c);
the apparatus is configured to:
output the interfered pulse such that the interfered pulse comprises an average of up to one photon;
output the interfered pulse, towards a further apparatus, for generating the quantum cryptographic key.

2. An apparatus as claimed in claim 1 wherein:
the at least one output path comprises at least a first (c) and second (d) output path; the first output path is spatially separate from the second output path;
the interfered EM pulses along the first (c) and second (d) output paths being associated with a path-encoded quantum cryptographic basis.

3. An apparatus as claimed in claim 2 further comprising an encoder for:
receiving interfered EM pulses output from the first and second output paths; and,
changing the path encoded quantum cryptographic basis to a different quantum cryptographic basis encoding using linear optical components.

4. An apparatus as claimed in claim 3 wherein the encoder is configured to change a path-encoded quantum cryptographic basis to a polarisation-encoded cryptographic basis using linear optical components.

5. An apparatus as claimed in claim 2, further comprising a first set of further optical elements (BS4, BS5); the first set comprising at least a first optical element (BS4) and a second optical element (BS5); wherein:
I) the first optical element of the first set configured to:
i) receive the interfered EM pulse from the first (c) output path;
ii) output a first portion of the said received interfered EM pulse on a path (e) towards the further apparatus;
iii) output a second portion on the received interfered EM pulse on a path (g) towards an arrangement of components comprising at least one EM detector (PD1, PD2, PD3, PD4); the said second portion referred to as a first check pulse;
II) the second optical element of the first set configured to:
i) receive the interfered EM pulse from the second (d) output path;
ii) output a first portion of the said received interfered EM pulse on a path (f) towards the further apparatus;
iii) output a second portion on the received interfered EM pulse on a path (h) towards the arrangement of components comprising at least one EM detector (PD1, PD2, PD3, PD4); the said second portion referred to as a second check pulse.

6. An apparatus as claimed in claim 5 wherein the at least one EM detector comprises:
a first EM detector (PD4) for receiving at least a first sub-portion of the first check pulse;
a second EM detector (PD1) for receiving at least a first sub-portion of the second check pulse.

7. An apparatus as claimed in claim 6 wherein the arrangement of components comprises:
a third EM detector (PD2) for receiving at least a:
second sub-portion of the first check pulse; and
second sub portion of the second check pulse;
a fourth EM detector (PD3) for receiving at least a:
third sub-portion of the first check pulse; and
third sub portion of the second check pulse.

8. An apparatus as claimed in claim 2 wherein the optical element (BS3) is a first optical element; the apparatus further comprising:
I) a second optical element (BS1) for:
i) receiving an EM pulse from the first set of EM pulses;
ii) receiving an EM pulse from a third set of two or more EM pulses; wherein a random phase relationship exists between the first set of EM pulses and the third set of EM pulses;
iii) interfering the two received EM pulses;
iv) outputting the interfered EM pulse as the first EM pulse for inputting into the first optical element;
II) a third optical element (BS2) for:
i) receiving an EM pulse from the second set of EM pulses;
ii) receiving an EM pulse from a fourth set of two or more EM pulses; wherein a random phase relationship exists between the second set of EM pulses and the fourth set of EM pulses;
iii) interfering the two received EM pulses
iv) outputting the interfered EM pulse as the second EM pulse for inputting into the first optical element.

9. An apparatus as claimed in claim 1 wherein any two or more of the sets of EM pulses share a common EM pulse source.

10. An apparatus as claimed in claim 1 wherein at least one of the EM pulse sources comprises a gain-switched laser.

11. (canceled)

12. An apparatus for generating a set of pulses for outputting to a further apparatus for the generation of a quantum cryptographic key; the apparatus comprising:
I) one or more electromagnetic, EM, pulse sources (L8, L9) for outputting at least a first set of one or more EM pulses and a second set of one or more EM pulses; wherein
at least a first EM pulse is based from at least one of the first set of EM pulses; and,
at least a second EM pulse is based from at least one of the second set of EM pulses;
wherein:
a) a random phase relationship exists between the first EM pulse and the second EM pulse;
b) a random phase relationship exists between the pulses of the first set of pulses;
c) each of the first and second EM pulses comprises a plurality of photons;
II) an optical element (BS18) comprising:
d) a first input path for receiving the first EM pulse;
e) a second input path for receiving the second EM pulse;
f) at least one output path;
wherein:
the first input path is spatially separate to the second input path;
the optical element (BS18) is configured to output at least:
i) a portion of the first EM pulse;
ii) a portion of the second EM pulse;
along the at least one output path;
the apparatus is further configured to:
output the portion of the first EM pulse such that the said portion comprises an average of up to one photon;
output the portion of the first EM pulse and the portion of the second EM pulse, in different time bins, towards a further apparatus, for generating the quantum cryptographic key.

13. An apparatus as claimed in claim 12 wherein the optical element is a first optical element (BS18); the apparatus further comprising:
I) a second optical element (BS16) for:
i) receiving an EM pulse from the first set of EM pulses;
ii) amplitude splitting the received EM pulse such that:
a first portion is output as the first EM pulse to the first optical element (BS18)
a second portion is output towards a heterodyne detection arrangement;
II) a third optical element (BS17) for:
iii) receiving an EM pulse from the second set of EM pulses;
iv) amplitude splitting the received EM pulse such that:
a first portion is output as the second EM pulse to the first optical element (BS18)
a second portion is output towards the heterodyne detection arrangement.

14. An apparatus as claimed in claim 13 further comprising a delay line for receiving the second portion output by the third optical element (BS17) and outputting the delayed second portion towards the heterodyne detection arrangement.

15. An apparatus as claimed in claim 13 wherein the heterodyne detection arrangement comprises:
I) first and second EM detectors;
II) at least a fourth optical element (BS21, BS22) for:
A) receiving:
i) the second portion from the second optical element;
ii) the second portion from the third optical element;
B) interfering EM pulses received from the first and second sets of EM pulses;
C) outputting interfered EM pulses to the first and second EM detectors.

16. An apparatus as claimed in claim 13 wherein the second set of EM pulses have greater intensity than the first set of EM pulses.

17-22. (canceled)

23. An apparatus for generating a quantum cryptographic key by outputting one or more EM pulses to a further apparatus; the apparatus comprising:
I) one or more electromagnetic, EM, pulse sources for outputting at least a first set of one or more EM pulses and a second set of one or more EM pulses; wherein at least a first EM pulse is based from at least one of the first set of EM pulses; and, at least a second EM pulse is based from at least one of the second set of EM pulses;
wherein:
i) a random phase relationship exists between the first EM pulse and the second EM pulse;
ii) each of the first and second EM pulses comprises a plurality of photons;
II) an optical element (BS3) comprising:
i) a first input path (a) for receiving a first EM pulse;
ii) a second input path (b) for receiving a second EM pulse;
iii) at least two output paths (c, d);
wherein:
the first input path (a) is spatially separate to the second input path (b);
the optical element (BS3) is configured to
interfere the first EM pulse with the second EM pulse;
output a first interfered EM pulse along a first output path (c);
output a second interfered EM pulse along a second output path (d);
III) a first set of further optical elements (BS4, BS5); the first set comprising at least a first optical element (BS4) and a second optical element (BS5); wherein:
A) the first optical element (BS4) of the first set is configured to:
a) receive the first interfered EM pulse from the first (c) output path;
b) output a first portion of the said received first interfered EM pulse on a path (e) towards the further apparatus;
c) output a second portion on the received first interfered EM pulse; the said second portion referred to as a first check pulse;
B) the second optical element (BS5) of the first set configured to:
d) receive the second interfered EM pulse from the second (d) output path;
e) output a first portion of the said received second interfered EM pulse on a path (f) towards the further apparatus; the first portions of the respective first and second interfered EM pulses being associated with a path-encoded quantum cryptographic basis;
f) output a second portion of the received second interfered EM pulse; the said second portion referred to as a second check pulse;
C) the combined intensity of: i) the first portion of the first interfered EM pulse; and ii) the first portion of the second interfered EM pulse; that is output from the apparatus to the further apparatus comprises an average of up to one photon;
IV) a second set of further optical elements configured to:
h) receive the first and second check pulses; and,
i) create spatially separated first, second and third sub portions of the first check pulse; and,
j) create spatially separated first, second and third sub portions of the second check pulse; and,
k) output the said sub portions in steps i) and j) for detection.

24. The apparatus as claimed in claim 23 further comprising an encoder configured to:
i) receive the first portion of the first interfered EM pulse;
ii) receive the first portion of the second interfered EM pulse;
iii) change the path encoded quantum cryptographic basis to a different quantum cryptographic basis encoding.

25. An apparatus as claimed in claim 24 wherein the encoder is configured to change a path-encoded quantum cryptographic basis to a polarisation-encoded cryptographic basis.

26. An apparatus as claimed in claim 23 wherein the optical element (BS3) is a first optical element; the apparatus further comprising:
I) a second optical element (BS1) for:
i) receiving an EM pulse from a first set of two or more EM pulses;
ii) receiving an EM pulse from a third set of two or more EM pulses;
iii) interfering the two received EM pulses;
iv) outputting the interfered EM pulse as the first EM pulse for inputting into the first optical element (BS1);
II) a third optical element (BS2) for:
i) receiving an EM pulse from a second set of two or more EM pulses;
ii) receiving an EM pulse from a fourth set of two or more EM pulses;
iii) interfering the two received EM pulses;
iv) outputting the interfered EM pulse as the second EM pulse for inputting into the first optical element.

27. An apparatus as claimed in claim 26 wherein the first, second and third optical elements are integrated optical elements monolithically integrated to form a common device.
